(19) United States
(12) Patent Application Publication
(10) Pub. No.: US 2015/0339765 A1
(43) Pub. Date: Nov. 26, 2015

(54) LIQUIDITY FORECASTING AND MANAGEMENT SYSTEM AND METHOD

(71) Applicant: THE BANK OF NEW YORK MELLON, NEW YORK, NY (US)

(72) Inventors: Vinay DUBEY, Edison, NJ (US); Alain Alexander Louis MEURRENS, New Rochelle, NY (US)

(21) Appl. No.: 14/718,534

(22) Filed: May 21, 2015

Related U.S. Application Data
(60) Provisional application No. 62/001,861, filed on May 22, 2014.

(51) Int. Cl. G06Q 40/00

(52) U.S. Cl. CPC G06Q 40/00

(57) ABSTRACT

A system for processing liquidity forecasting decisions includes one or more processors configured to execute one or more program modules. The modules are configured to receive, via the one or more processors, a forecast for an account at a forecast timestamp. The modules are also configured to identify, via the one or more processors, a forecast rule using attributes from the forecast. Responsive to the forecast rule having a milestone associated therewith, the modules are configured to retrieve, via the one or more processors, a milestone time associated with the milestone, compare, via the one or more processors, the forecast timestamp to the milestone time, and apply, via the one or more processors, a forecast decision based on the comparison of the forecast timestamp and the milestone time. Applying the forecast decision includes determining a confidence level that a transaction associated with the forecast will occur by a given time.

### CROSS-REFERENCE TO RELATED APPLICATIONS

This application claims priority to U.S. Provisional Patent Application No. 62/001,861, filed May 22, 2014, entitled “Liquidity Forecasting and Management System and Method,” the contents of which are incorporated by reference in its entirety herein.

### BACKGROUND

This application is directed to computer-implemented systems and methods useful for analysis of liquidity on an enterprise perspective (e.g., to estimate liquidity availability), and to provide forecasting analysis based on transactions in light of the liquidity analysis.

Among other things, what is needed is a system and method for the financial services provider to monitor liquidity data on an enterprise level, facilitating holistic management of liquidity at the financial services provider.

### SUMMARY

According to an embodiment, a system for processing liquidity forecasting decisions includes one or more computer processors configured to execute one or more computer program modules. The program modules are configured to receive, via the one or more processors, a forecast for an account at a forecast timestamp. The modules are also configured to identify, via the one or more processors, a forecast rule using attributes from the forecast. Responsive to the forecast rule having a milestone associated therewith, the modules are configured to retrieve, via the one or more processors, a milestone time associated with the milestone, compare, via the one or more processors, the forecast timestamp to the milestone time, and apply, via the one or more processors, a forecast decision based on the comparison of the forecast timestamp and the milestone time. Applying the forecast decision includes determining a confidence level that a transaction associated with the forecast will occur by a given time.

According to another embodiment, a computer implemented method for processing liquidity forecasting decisions, implemented in a computer system comprising one or more processors configured to execute one or more computer program modules, includes receiving, via the one or more processors, a forecast for an account at a forecast timestamp, and identifying, via the one or more processors, a forecast rule using attributes from the forecast. Responsive to the forecast rule having a milestone associated therewith, the method includes retrieving, via the one or more processors, a milestone time associated with the milestone, comparing, via the one or more processors, the forecast timestamp to the milestone time, and applying, via the one or more processors, a forecast decision based on the comparison of the forecast timestamp and the milestone time. Applying the forecast decision comprises determining a confidence level that a transaction associated with the forecast will occur by a given time.

The system and method of this disclosure provides various capabilities as discussed more fully in the detailed description below.

### BRIEF DISCUSSION OF THE DRAWINGS

FIG. 1 illustrates a networked computer relationship between a liquidity management system and various computer subsystems of a financial services provider;

FIG. 2 illustrates a functional overview of an embodiment of the liquidity management system;

FIG. 3 illustrates an embodiment of a process flow for automated liquidity forecasting decision-making;

FIG. 4 illustrates an embodiment of a method for processing liquidity forecasting decisions;

FIG. 5 illustrates another embodiment of an automated liquidity forecasting decision-making process;

FIG. 6 illustrates an embodiment of a machine learning and forecasting decision-making process; and

FIG. 7 illustrates an exemplary computer system configured to perform the functions of systems and methods described herein.

### DETAILED DESCRIPTION

In the discussion of various embodiments and aspects of the system and method of this disclosure, examples of a processor may include any one or more of, for instance, a personal computer, portable computer, personal digital assistant (PDA), workstation, or other processor-driven device, and examples of network may include, for example, a private network, the Internet, or other known network types, including both wired and wireless networks.

Those with skill in the art will appreciate that the inventive concept described herein may work with various system configurations. In addition, various embodiments of this disclosure may be made in hardware, firmware, software, or any suitable combination thereof. Aspects of this disclosure may also be implemented as instructions stored on a machine-readable medium, which may be read and executed by one or more processors. A machine-readable medium may include any mechanism for storing or transmitting information in a form readable by a machine (e.g., a computing device or a signal transmission medium), and may include a machine-readable transmission medium or a machine-readable storage medium. For example, a machine-readable storage medium may include read only memory, random access memory, magnetic disk storage media, optical storage media, flash memory devices, and others. Further, firmware, software, routines, or instructions may be described herein in terms of specific exemplary embodiments that may perform certain actions. However, it will be apparent that such descriptions are merely for convenience and that such actions in fact result from computing devices, processors, controllers, or other devices executing the firmware, software, routines, or instructions.

Described herein is an exemplary system which may be implemented through computer software running in a processor to provide liquidity data analytics. This description is not intended to be limiting, but is merely provided to describe ways of accomplishing the functions associated with acting as a financial service provider on behalf of an asset owner or investor.

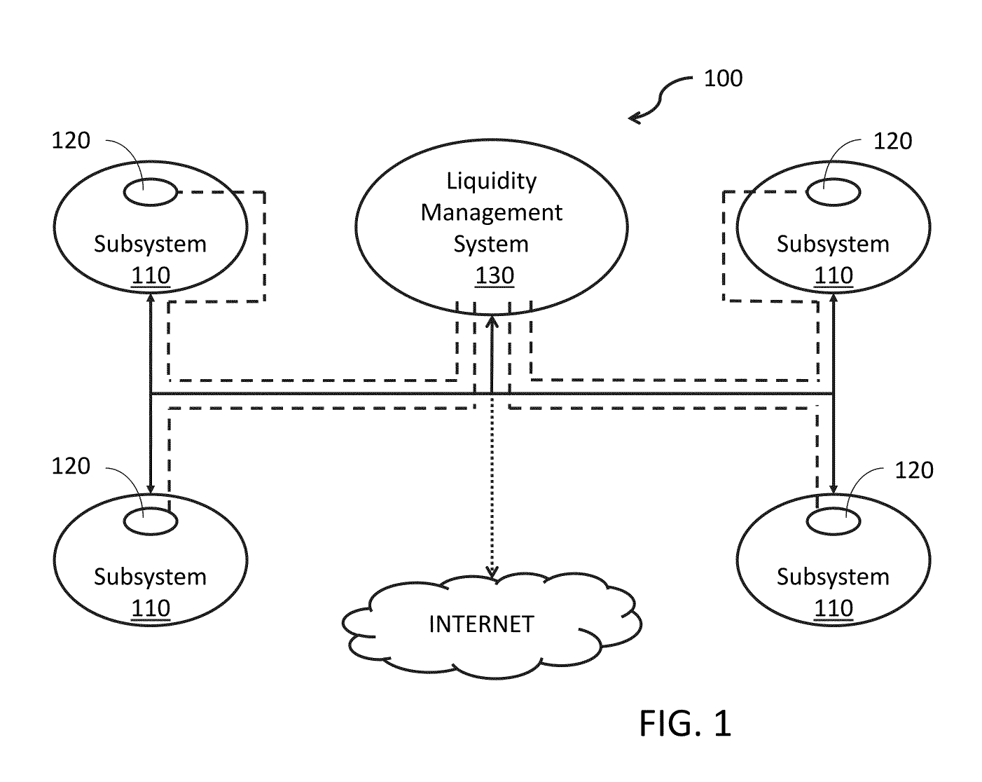

FIG. 1 schematically illustrates a networked relationship 100 between various subsystems 110 of a financial services provider. As shown, cash balance and transactional data 120 associated with each of the subsystems 110 may be relayed (e.g., copied, transmitted, or otherwise provided to) a liquidity management system 130 that is part of the networked relationship 100. In an embodiment, such cash balance and transactional data 120 may be relayed to or otherwise gathered by the liquidity management system 130 on a real-time basis. In some embodiments, the cash balance and/or transactional data 120 may be relayed to or otherwise gathered by the liquidity management system 130 on a periodic or intermittent basis, including but not limited to hourly, after a set number of minutes, and/or upon new cash balance and/or transactional data 120 being received by the financial services provider. It may be understood that the networked relationship 100 may include coupling computer systems or processors associated with each of the financial services provider subsystems 110, and/or other computer systems servicing the subsystems 110, either at or remote to the financial services provider.

In an embodiment, the cash balance and/or transactional data 120 may be understood as that data which describes financial liquidity for the financial services provider. It may be appreciated that the liquidity management system 130, by accumulating cash balance and/or transactional data 120 in a common system, may facilitate making automated decisions, or assist user decisions for purposes of managing actual and forecasting liquidity. Such decisions may be useful in optimizing end-of-day cash positions for the financial services provider.

In an embodiment, a liquidity decision may be made before the end of the local business day (i.e., before the other bank's deadline or market closure), where the forecasted nostro position may typically be managed down to approximately a zero balance. In an embodiment, one such liquidity decision may be a funding decision. In an embodiment, a funding decision may comprise a liquidity analyst or other party moving the forecasted cash balance to/from another account where the cash is concentrated. In an embodiment, the cash may be moved to the concentration account in case of a ‘long’ balance, i.e. excess cash. In an embodiment, the cash may be moved from the concentration account to the nostro in case of a ‘short’ balance (i.e. a shortfall of cash). In an embodiment, another type of decision may include an investment decision. In an investment decision, typically a trader from Corporate Treasury may decide to not invest at least a portion of their cash position and/or may trade with another financial institution to either borrow from them in order to cover a short balance, or lend to them in order to place a long balance.

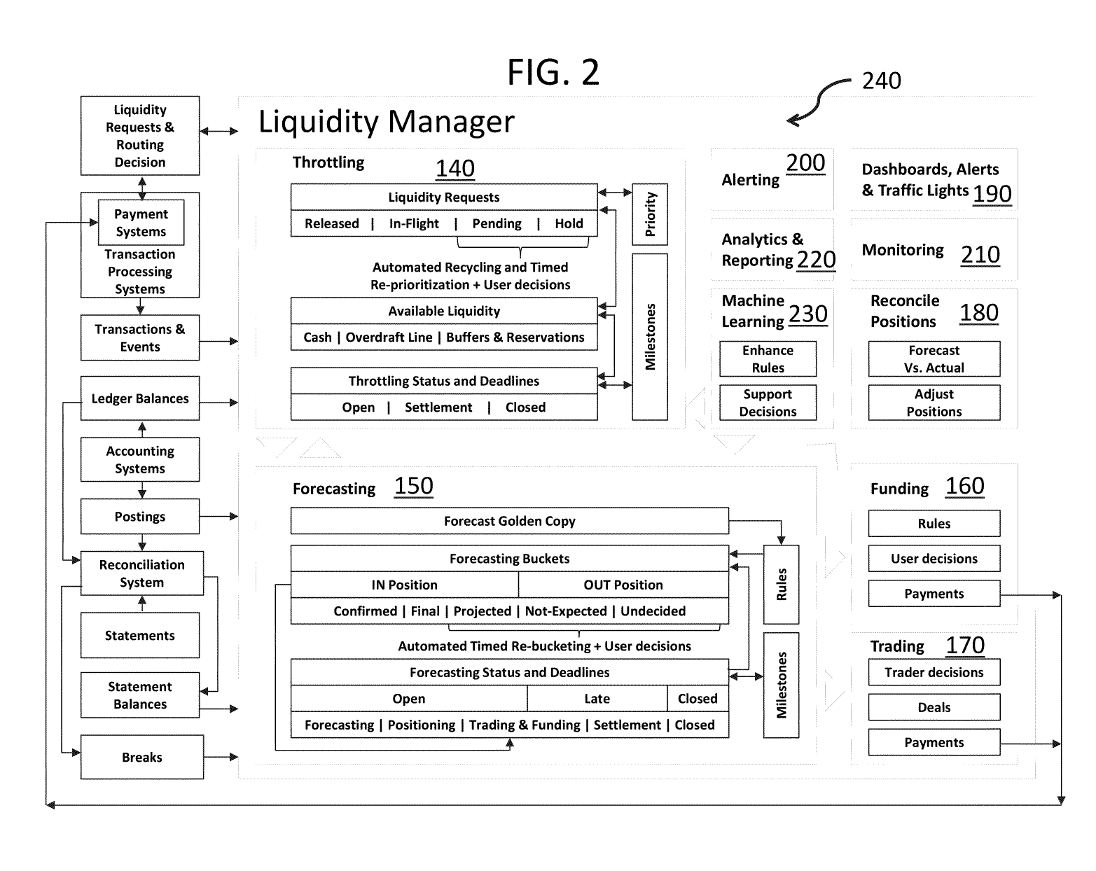

FIG. 2 illustrates a functional overview of an embodiment of the liquidity management system 130. As described herein, in various embodiments the liquidity management system 130 may be configured to provide throttling functionality 140, forecasting functionality 150, funding functionality 160, trading functionality 170, and/or reconciliation functionality 180. It may be appreciated that such functionalities may support the various subsystems 110 of the financial services provider across a plurality of currencies in some embodiments. In some embodiments, access to some of the functionalities, or portions thereof, may be limited or permitted based on user permission controls (e.g., a user login associated with the computer systems used by users to access the liquidity management system 130). As described in greater detail below, in an embodiment the users may each be associated with different tasks at the financial services provider. For example, a control user may be tasked with throttling transactions, monitoring of the clearing channels and monitoring the technical health of the application and its interfaces. In an embodiment, a liquidity analyst user may be tasked with forecasting, funding and next day reconciliation. In an embodiment, a trader user may be tasked with covering the financial service provider's cash positions in the market. In an embodiment, a client services user may be tasked with monitoring their client's activity and associated liquidity. In an embodiment, an operations user may support the forecasting decision making process, and provide non-systemic forecasts.

As described in greater detail below, in an embodiment the throttling functionality 140 may comprise the algorithms and software programs configured to regulate payment flow to cash clearing channels or correspondents banks associated with or otherwise networked to the financial services provider (e.g., regulating the payment flow to the market, as a payment scheduler). Such regulation and throttling in the throttling functionality 140 may vary such payment flows based on the available liquidity. In an embodiment, the forecasting functionality 150 may project or predict a likely closing balance associated with a correspondent or clearing channel at a given time (e.g., at the end of the business day). In an embodiment, forecasting may be the process of projecting the daily closing balance for a cash account. It may be appreciated that in an embodiment the daily closing balance may be projected as denominated in any currency. While forecasting is typically done for a nostro account, i.e. an account held with another bank, it can also be performed for a client account or any other type of account. In an embodiment, forecasting may include actual numbers which have already been confirmed by the institution where the account is held, i.e. the central bank clearing or correspondent bank. In an embodiment, forecasting may also consider the non-confirmed transactions of which the users (e.g., the liquidity analyst users) are aware, but that have not yet occurred at least in part.

In an embodiment, the funding functionality 160 and the trading functionality 170 may together be configured to allow the financial services provider to manage positions by concentrating cash on a number of accounts, and advise traders what amounts should be considered for lending the excess cash of the financial services provider, or borrowing for a shortfall of cash of the financial services provider. In an embodiment, the reconciliation functionality 180 may be configured to compare forecasted positions against actual balances associated with a correspondent or clearing channel. Such comparison may be at a later date (e.g., after the initial business date or other time associated with the forecasting functionality 150). It may be appreciated that in some embodiments supporting features may be implemented to support the various functionalities described herein, including but not limited to dashboard user interfaces and/or traffic light user interfaces 190, alerting 200, monitoring 210, tangential analytics 220, and machine learning features 230, as discussed in greater detail below. It may be appreciated that, as understood herein, the business date may be the date for which the forecasting is done. In many embodiments the business date may be the same as the calendar day. In some embodiments, and in some markets, however, the business date may be one or two days ahead of the current calendar day, which means that forecasting happens for a future date. In an embodiment, the forecasted position for a given value date may include transactions with a value date equal or smaller than the business date.

It may be appreciated that in an embodiment, a forecasted position may be the opening balance for the day, (e.g., the previous day's closing balance) plus any forecasted transactions which result in cash coming into the financial services provider, minus any forecasted transactions which result in cash going out from the financial services provider. In various embodiments, transactions which result in cash coming into the financial services provider may include the buy side of a foreign exchange trade, a payment from another bank, the delivery of securities versus payment (DVP), or so on. In various embodiments, forecasted transactions which result in cash going out may include, for example, the sell side of a foreign exchange trade, a payment to another bank, the receipt of securities versus payment (RVP), or so on.

As used herein, ‘transaction’ may represent any sort of financial transaction, including but not limited to a payment, a receipt of funds, a securities settlement, a dividend payment, a foreign exchange, a loan, and a letter of credit. In an embodiment, these transactions may be processed on a variety of banking systems, such as payment systems, securities settlement systems, trading systems, portfolio services systems, trade finance systems, and so on. In an embodiment, transactions may post to accounting systems which may be configured to capture associated debits and credits based on calculated account balances. In an embodiment, a general ledger system may be used to produce the balance sheet for the financial services provider. It may be appreciated that by capturing transactions from all of the financial services provider's relevant systems in real time, the data may be considered for forecasting and establishing a forecasted position. In an embodiment, transactions that cannot be captured for whatever reason may be noted to prompt manual adjustment of the position, so that they may be included, if applicable.

In an embodiment, the throttling functionality 140 may facilitate management of the flow of payment transactions into various cash clearing channels, including but not limited to the Fed (US), Target2 (Europe), Chaps (UK), and Chats (Hong Kong). In an embodiment, the throttling functionality 140 may be configured to reserve liquidity for future transactions, such as those not yet received by the liquidity management system 130. In an embodiment, the throttling functionality 140 may be configured to schedule payments to parties outside of the financial services provider, or may be configured to clear or settle accounts against a cash balance or a predefined intraday credit limit. In an embodiment where the throttling functionality 140 is configured to clear or settle against a predefined credit limit, such limit may be calculated based on collateral lodged with a central bank or clearing system. It may be appreciated that in some embodiments clearing channels may require members to meet throughput requirements based on payment value and volume, so as to ensure that sufficient liquidity remains in the market(s).

In an embodiment, the throttling functionality 140 may be configured to provide users at the financial services provider (e.g., direct or indirect users of the liquidity management system 130 and/or the subsystems 110) with real-time (or substantially real time) information regarding the pending payments queue, payment execution, intraday balances, and/or available liquidity, so that such users may make informed decisions. In an embodiment, the liquidity management system 130 may be configured to automatically release payment requests as long as there is available liquidity. It may be appreciated that the throttling functionality 140 may delay or prevent such automatic releases of payments in some embodiments. In an embodiment, available liquidity may be monitored periodically or continuously, and may provide appropriate alerts to the user if payments remain pending or if available liquidity is below a threshold amount (e.g., the amount for automatically releasing payments). In an embodiment, a user interface linked to the liquidity management system 130 and/or the subsystems 110 may allow users to optionally release pending payments manually, or hold the pending payments for release at a later stage, such as when additional liquidity is available. In an embodiment, certain user accounts may have additional permissions over other user accounts, and may, for example, release payments that exceed the available liquidity and/or liquidity limits.

It may be appreciated that in some embodiments the throttling functionality 140 may be configured to utilize a clearing channel profile, which may set default values on a daily basis, and may in some embodiments make intraday changes to regulate payment flow. In an embodiment, the throttling functionality 140 may be selectively enabled or disabled, and may automatically release against cash plus potentially some or all of an overdraft line. In an embodiment the throttling functionality 140 may be configured to selectively release all transfers/payments, require manual approval of transfer/payments, or suspend all payments (e.g., until a condition is met, such as passage of time or liquidity becomes available). In an embodiment a throttling functionality 140 may be configured to activate or deactivate (e.g., selectively throttle payments or not), or modify its behavior, based on certain conditions, such as closing for certain message types, closing for the remainder of the day, or enters a settlement mode. In an embodiment, the throttling functionality 140 may have defined or modifiable limits, which may define how much of an overdraft line may be accessed during automatic release. In an embodiment, target balances may be established, such that the throttling functionality 140 may allow users to auto-release payments as long as the balance threshold (which can be either positive, negative, or zero) isn't exceeded or surpassed. According to some embodiments, buffers or reservations may be implemented in the throttling functionality 140, which may hold liquidity for future transactions. If the future transaction is known, certain liquidity may be reserved specifically for the transaction. If the future transaction is not known, a buffer may be utilized for unallocated liquidity. In some embodiments, pending payments may be recycled for release after liquidity increases or the status of the throttling functionality 140 changes. In various embodiments, liquidity can increase because additional credits are received by the financial services provider, because a limit is increased, buffers are lowered, or so on. In some embodiments, the throttling functionality 140 may be configured so that users may assign payment priority to certain requests (e.g., based on rule sets), and may in an embodiment modify priority assignments while requests are pending.

In an embodiment, the forecasting process 150 may be configured to predict a likely closing balance for an account with a correspondent bank or clearing system before any applicable deadlines, in time to cover the financial service provider's projected balances. In an embodiment, the forecasting process 150 may recommend whether a forecast should be taken into or left out of position. It may be appreciated that if a forecast is ‘taken in position,’ then it is included in the figure that is used for funding or investing. On the other hand, if a forecast is ‘left out of position,’ then it is excluded from the figure used for funding or investing.

For example, if a client expects another party to wire them funds, there is no guarantee of the transfer until the funds are confirmed by the market; there is uncertainty in the wire. As another example, where a client buys securities from their counterparty, and the client doesn't have enough securities available on the settlement date to settle the trade, it is possible that settlement, or only partial settlement, would result in no movement of cash or only limited movement of cash. Accordingly, because there isn't always certainty that a transaction will take place on the forecasted value date (i.e. the effective date with which a transaction becomes part of the account balance), in an embodiment a system and/or user may decide whether a forecast is taken into position, or not. It may be appreciated that in the context of forecasting, interest calculations may be based on the account balance for each value date. For example, if the date of a transaction is May 1^{st}, the value date is May 2^{nd} and the transaction actually posts on May 5^{th}; the transaction may update the balance for May 2^{nd} backvalue, even though it only posts on May 5^{th}, and interest may be applied on the updated balance with value May 2^{nd}. In an embodiment, once a transaction actually takes place on or after the original value date, then the accounting is posted. The resulting posted debits and credits may be understood as the postings related to the transaction. In an embodiment, the postings may replace the related forecasts, because the forecasts would now be included in the account balance after posting.

As used herein, a ‘forecast’ relates to one of the cash legs of a transaction. In an embodiment, a market transaction may have 2 forecasts, one to debit/credit a client account, and the other one to credit/debit a nostro account. For example, for a payment a debit may go to a client account and a credit may go to a nostro account. For an internal transaction, one client account may be debited and another may be credited, or the transaction may debit/credit a client account and credit/debit an internal account respectively. In an embodiment, there may be more than two forecasts for the same transaction for a variety of reasons. For example, there may be more than two forecasts for the same transaction as charges are applied, bulk amounts are split, suspense accounts are required to settle transactions, more than one legal entity is involved to settle a transaction, a profit/loss needs to be realized, or so on. It may be appreciated that in an embodiment, for each of the separate debits and credits there is a separate forecast, no matter whether nostro, client, internal or other accounts are involved. In an embodiment, each forecast is a candidate to contribute to the forecasted position of the account associated with the forecast.

In an embodiment, not all forecasts for the same transaction would be received at the same time as one unit of work. For example, the liquidity management system 130 may receive multiple pieces at different times, from one or more source systems. In an embodiment, any system that can contribute with additional information about a transaction may be able to relay it to the liquidity management system 130, which may match up all the pieces based on unique references. In an embodiment, there may be multiple events for the same forecast. In such an embodiment, the first event may create the actual forecast, while subsequent events (e.g., updates to the forecast) may be received as the transaction progresses through its life cycle. In an embodiment, the time at which these events are received may be referred to as the forecast timestamp, which may make available additional information for decisioning purposes, regardless of source. In such an embodiment, the associated details would be the most up to date ones available in real time. In an embodiment, the transaction may be for one or more of the financial services provider's legal entities (e.g., going across multiple entities in case one is using the other as their correspondent bank).

In some embodiments, confidence levels may be assigned to transactions so that users may determine the appropriate liquidity amounts. In an embodiment, the systems of the financial services provider may determine when to initiate funding transfers between accounts, or may advise traders of the amount they can cover in the market, for example. It may be appreciated that in an embodiment the forecasting functionality 150 may utilize the same transaction data that is utilized for the throttling functionality 140, however where the throttling functionality 140 utilizes actual data (e.g., confirmed and final transaction data taken at a certain point in time), the forecasting functionality 150 may take both the actual data (e.g., the confirmed and final transaction data) as well as non-confirmed transaction data. In an embodiment, the forecasting buckets may be assigned by the liquidity management system 130 based on forecasting rules and/or user decisions.

In an embodiment, forecasts may be categorized into different buckets based on the confidence that the financial services provider (e.g., the systems thereof) has that the transactions will actually occur. For example, in an embodiment the forecasting buckets may include a confirmed bucket, which may be the forecasts which have been confirmed by the market. In an embodiment, the correspondent bank or clearing house may confirm the forecast, causing the forecast to be placed in the confirmed bucket. In an embodiment the forecasting buckets may include a final bucket, which may be the forecasts which have a very high confidence level, even though they have not been confirmed by the market. For example, a forecast for a foreign exchange trade executed by the financial services provider may be placed in the final bucket. In an embodiment the forecasting buckets may include a projected bucket, which may be the forecasts which the financial services provider is confident enough to take into position, even though there is no certainty that the forecast will actually occur. For example, the projected bucket may include forecasts where the financial services provider has a preadvice of incoming funds which has been confirmed by the client of the financial services provider. In an embodiment the forecasting buckets may include a tentative bucket, which may include the forecasts for which the financial services provider has no indication that the forecast will take place, and for which the financial services provider is not sufficiently confident to take the forecast into position. For example, in an embodiment, a forecast for a security settlement trade with a specific failed reason code may be placed in the tentative bucket. Such a failed reason code may include the client of the financial services provider not having sufficient stock to settle the trade, for example. In an embodiment, an undecided bucket may be used to group forecasts for which the liquidity management system 130 cannot make an automated decision. For example, a forecasting rule for the forecast may indicate that the transaction must be presented to a user for manual decision.

In an embodiment the liquidity management system 130 may include into their position the opening statement balance plus confirmed, final, and projected forecasts from the forecasting functionality 150. In an embodiment, tentative and undecided forecasts may be left out of position. It may be appreciated that users of the liquidity management system 130 may use the position to provide corporate treasury with the amount of liquidity believed to be available, and may estimate how much should be invested.

In an embodiment, once a transaction takes place, the accounting associated with it may be finalized, and the determinations are used to take the forecasts down, so that the forecasts (for the now final transactions) are not used in the forecasting buckets. In an embodiment, statistics or other data associated with the correctness of the forecasts may be analyzed, or stored for future or cumulative analysis.

As described in greater detail below, in an embodiment the forecasting functionality 150 may make use of milestones. In an embodiment, such milestones may include timed or user initiated triggers, which may represent certain market events, or internal triggers. As an example, the milestones may include market events such as the opening and closing of the clearing, or a correspondent deadline. Similarly, internal trigger points, such as a set time that the financial services provider decides to reevaluate forecasts that aren't final, or a time when the liquidity management system 130 begins end-of-day positioning processing. In an embodiment, a user may determine if and which automated processes may begin upon reaching the milestone. For example, upon reaching the milestone, the forecasting functionality 150 may change the forecasting bucket. As another example, upon reaching the milestone, the forecasting functionality 150 may consider any new forecasts as being ‘late,’ as described in greater detail herein. In an embodiment, a user receiving the late forecast may decide whether they wish to still take late forecasts into position, for example.

In some embodiments, the forecasting functionality 150 may re-bucket prior forecasts as the time approaches the market cutoff (e.g., as one of the milestones), where the likelihood diminishes that the non-final transactions will actually occur. It may be appreciated that in an embodiment forecasting rules may have a re-bucketing component that may prompt re-bucketing when certain milestones are met. In an embodiment, the liquidity management system 130 may present the non-final forecasts to users for their decision on whether to include the forecast in the position or not.

In an embodiment, groupings of accounts may be managed together from a forecasting perspective. For example, a grouping of nostro accounts in the same currency may be managed together for a particular entity of the financial services provider, which may facilitate managing a single position per entity, or managed on a financial service provider-level so that traders can look for opportunities to trade positions within the financial services provider instead of doing separate market deals to square positions. It may be appreciated that while separate market deals may go in different directions (i.e., borrow or lend), it would be preferable for to instead have one or a few trades within the financial services provider, which may go in the same direction.

In an embodiment, clients and/or their associated forecasts may be grouped together for analysis if they belong together (e.g. accounts for the same client) or have similar behavior (e.g. all broker dealer clients tend to manage their account to zero at the end of the day after huge intraday swings). In an embodiment, clients that manage their account to a given balance (zero, positive or negative) can be set up with ‘predicted balances’, so that throughout the day the financial services provider may ignore their individual forecasts that create large swings in the forecasted positions of the liquidity management system 130. In an embodiment, the user may at some point determine whether they will continue using the predicted balances, or will look at the actual forecasts (e.g., if it is identified that the client is not following its typical behavior). In an embodiment, the liquidity management system 130 or its users may take forecasting ‘snapshots,’ which can be subsequently used to reconstruct as to how the forecasts and associated positions looked like at the time that each snapshot was taken. In an embodiment, such snapshots may serve as both an audit trail and as an analysis tool. In some embodiments, automated snapshots may be taken at the time that the figures are identified for the traders, or at the time that the forecasting is rolled over to the next business day. In an embodiment, users may take snapshots throughout the day (e.g., at their initiative).

In an embodiment, the liquidity management system 130 may be configured to provide users with access to real time forecasts details, which may be acquired from a variety of sources that contribute separate forecasts, or enrich forecasts from one another with additional details. In an embodiment the liquidity manager may accept details for the same transaction from various sources, which may use the data to create forecasts that contain elements from each of the sources, all for the purpose of having as much as possible complete and up to date information available for making automated or user decisions.

In an embodiment, the liquidity management system 130 may be configured to allow users to raise manual forecasts (e.g., temporarily), in case forecasts could come in late. Similarly, in an embodiment the liquidity management system 130 may be configured to allow users to create reoccurring forecasts, which may include manual forecasts that are expected to happen on a daily basis, or on some other reoccurring basis. In an embodiment, informational buckets may be provided, which may allow users to see forecasts that have unexpected impacts on positions (e.g., cancellations and late items), or are otherwise outside of normal practice, such as daily reoccurring daily forecasts which have not yet, before their expected deadline. In an embodiment, the liquidity management system 130 may be configured to allow users to focus on material amounts (e.g., the smaller volume of high value amounts, as opposed to a high volume of small value amounts), as such material amounts may have greater impact on the user's forecasts and determinations. As such, in an embodiment the liquidity management system 130 may be configured to allow users to focus on material amounts first and then move on to significant or non-material amounts. In various embodiments, materiality can be set up to depend on the currency, market, correspondent, or so on.

As described above, it may be appreciated that the forecasting functionality 150 may interact with the funding functionality 160 and the trading functionality 170. In an embodiment, once the forecasted positions are available, the liquidity management system 130 may facilitate the user making funding and trading decisions. For example, some users may typically fund most of the associated nostro accounts, so that an acceptable balance is maintained, cash may be concentrated on a particular account that is then covered by traders. In an embodiment, the liquidity management system 130 may be configured so that users can set up rules that determine the funding pairs, and determine which funding should occur automatically at a given milestone, or should be proposed for user evaluation. In an embodiment, after analyst users finalize their figures for trader users, trader users may see the analysts' figures appearing as confirmed positions. In an embodiment, after the figures appear as confirmed positions, the trader users may then make their trading decisions. These positions may then be controlled by the traders until they have indicated how they want to use and clear them.

In an embodiment, once actual statement balances are received from the financial service provider's correspondent bank, or the clearing channels that the financial services provider participates in, the liquidity management system 130 may compare these statement balances against the forecasted positions, and may make note of any material differences. In an embodiment, the materiality may be defined by the user. In an embodiment, some positions may be due analysis. It may be appreciated that such positions may be presented to the user with possible explanations. For example, an explanation may include noting transactions that potentially explain the difference, such as a transaction which occurred with the financial services provider's correspondent that the financial service provider was unaware of. In an embodiment, an explanation may include a note that the received data was confirmed too late to be used when taking forecasts into position. In an embodiment, a transaction for which the financial services provider decided to not take into position, but which happened after all, may also be noted. It may be appreciated that user analysis of such explanations may allow the user to take corrective actions, if possible, for the next business day.

As noted above, in some embodiments supporting features may be implemented to support the various functionalities described herein, including but not limited to dashboard user interfaces and/or traffic light user interfaces 190, alerting 200, monitoring 210, tangential analytics 220, and machine learning features 230. In an embodiment, the dashboard user interfaces and/or traffic light user interfaces 190 may be configured to provide users with a quick overview of key performance indicators. For example, such an interface may be configured to enable a user to go to from a listing of where they can take actions to the underlying details, so they can take such appropriate actions. In an embodiment, alerts and traffic lights (e.g., alerting 200 and user interfaces 190) may be used to attract attention of the users, in case of identified issues, such as the breach of a defined tolerance level. In an embodiment, monitoring 210 may be configured to allow a user to monitor the financial services provider's cash positions and the status of transactions in the clearing systems in real time. In an embodiment, data may be refreshed as an update happens, automated based on an interval, or by manual selection to refresh. In an embodiment, the analytics 220 may be configured to allow data processed by the liquidity management system 130 to be divided and viewed in a variety of ways, to facilitate user decision making. In an embodiment, machine features 230 may be configured to process prior decisions and outcomes in the past, to support future user decision making and will be described in greater detail below. In particular, the machine learning 230 may find patterns within prior decisions and outcomes in the past for the purposes of making more accurate forecasting decisions which lead in better investment of the account balances (e.g. nostro account balances) for increased revenues and reduction in cost. In one embodiment, the machine learning 230 may provide suggested forecasting decisions in real time in situations where regular forecasting rules cannot make an automated decision or where the user requires additional assistance to make an informed decision. In another embodiment, the machine learning 230 may enhance the regular forecasting rules to further refine the automated forecasting decisions and improve the accuracy of the decisions as to whether a given forecast should be taken into position or not. For example, in an embodiment forecasting may be revisited, as may be modification of appropriate alert levels, maintaining the necessary liquidity depending on the date and time, providing the chance that a transaction will take place based on attributes like who is the client, the counterparty, the correspondent, the type of transaction, and so on.

It may be appreciated that in some embodiments, users may define what transaction related decisions necessitate multiple levels of review. In an embodiment, approval may be based on how material the amount is, so that users may focus on amounts that have a material impact for a given currency or account. In an embodiment, the liquidity management system 130 may be configured to facilitate users assigning accounts to teams or individuals, so that they can monitor the progress at any point in time and ensure that all accounts are getting managed on a daily basis even if the person who is usually managing them is absent. In an embodiment, if a user cannot make a forecast bucket decision for whatever reason, they may send a request to the area which has the information or authority to make the decision, such as an operational area like trade settlement, or the client services officer. In an embodiment, the client or other department may incur a charge in case a wrong decision is taken.

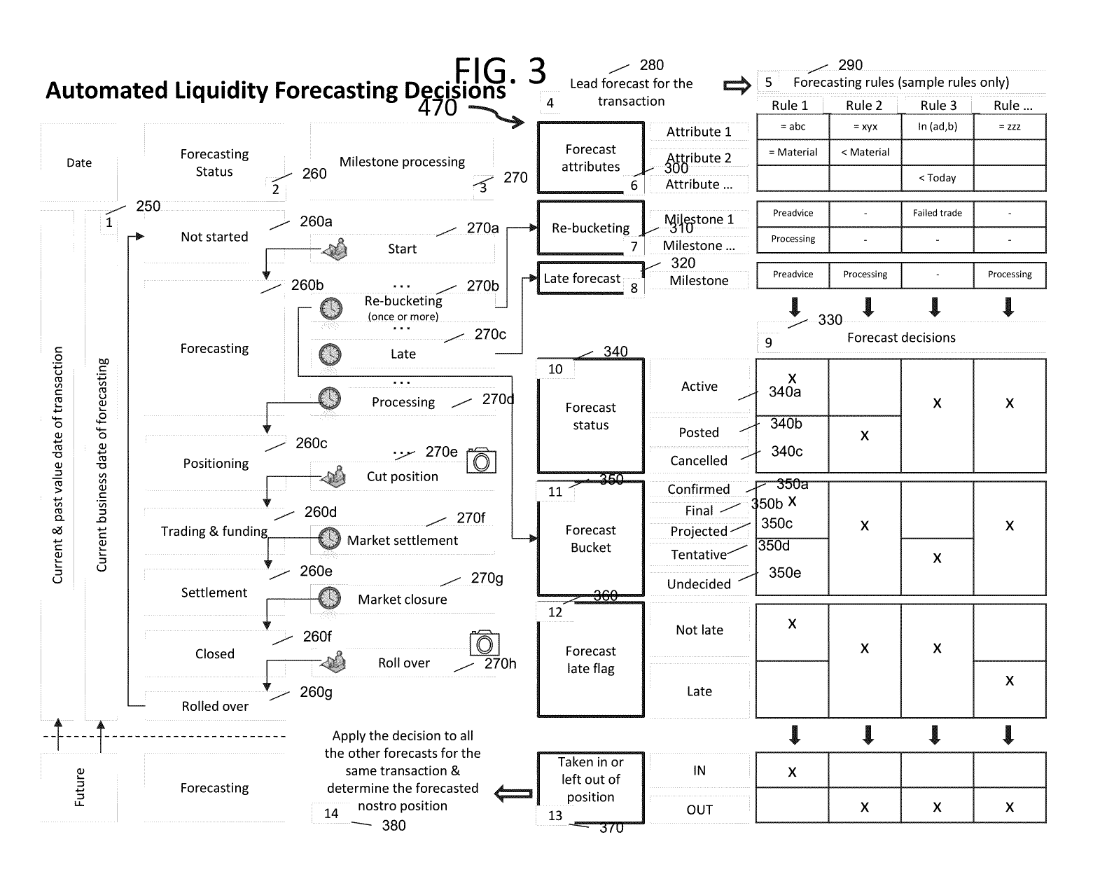

While embodiments of the liquidity management system 130, and in particular the forecasting functionality 150 thereof, may vary across embodiments as described herein, an embodiment of the forecasting functionality, forecasting decisions may link to milestone processing, as further described in FIG. 3. FIG. 3 illustrates a process flow 240 for automated liquidity forecasting decision-making, which may be implemented on the one or more processors of the liquidity management system 130.

As shown at 250, in an embodiment the forecasting process 240 may occur during the current business date. As such, when an account (e.g., a nostro account) is initially set up, the users determine its first business date. From that point on the account may be rolled over on a daily basis. As part of that roll over, forecasts which were received with a future value date and hence a future business date may at some point have the same value date as the designated current business date for forecasting, at which time forecasting may commence. In an embodiment, any forecasts which are not posted on value date may remain outstanding for the current business date. As such, the current business date may contain forecasts with a value date equal or smaller to the current business date.

It may be appreciated that a forecasting status 260 may track the various stages of forecasting an account (e.g., a nostro). Initially, the forecasting status 260 might indicate that forecasting has not started. When forecasting has not yet started, at 260a, e.g., after rolling over an account from one business day to the next, a user has not yet started to look actively at the account. Before forecasting has started, the forecasts and their updates may be collected as usual without being late, because the current business day has yet to begin. For example, if the present day is Wednesday, and an associated market closes at 6 PM, then after all final actions from the users to finish up the Wednesday, they may roll over the nostro account to the next business day (i.e. Thursday), at a designated time (e.g., 6:30 PM). It may be appreciated that users of the liquidity management system would not look at the Thursday's activity until sometime on Thursday (e.g., late morning or early afternoon, depending on the nostro account).

Once a user is ready to actively start looking at the forecasts for the account they can designate the forecasting status 260 of the account as forecasting, at 260b, which may show that the account is now being actively worked on. As an indicator tag for the liquidity management system 130, the forecasting status 260 indicating forecasting 260b may serve as a useful control mechanism for management, to ensure that the account is timely looked at.

The positioning status, 260c, may indicate that the user is in the process of establishing their position. While positioning at 260c, new forecasts that have an impact for the current business date, or updates which move a forecast from in position to out of position (or vice versa), may be considered late, and may be flagged for a user's decision. In an embodiment the trigger to move the status from forecasting at 260b to positioning at 260c may be reaching a designated time, as all areas which operate the source transaction processing systems may be aware of the deadlines with which forecasts may need to be provided to the liquidity analyst users. It may be appreciated that this designated time may be characterized as a milestone, as described herein.

In an embodiment, a trading & funding status 260d may indicate that the liquidity management system 130 and/or its users (e.g., the traders) are taking the actions to square out the position by funding or investing. In an embodiment, the trigger to move the status from positioning at 260c to trading & funding at 260d may be user initiated, and may be manually executed when the position is firmed up, and is ready to go into the funding or investment process. In an embodiment, an automated snapshot may be taken after moving the status from positioning at 260c to trading & funding at 260d, so that the evidence of the position may be kept so that users can go back to it for further reference.

The settlement status 260e may indicate that the market is closed for regular customer and interbank payments, as clearing banks are then settling their positions between each other. In an embodiment, the settlement status 260e may apply to nostro accounts related to direct cash clearing. In an embodiment, the settlement status 260e may be skipped for correspondent banks. It may be appreciated that the trigger to move the status from trading & funding at 260d to settlement at 260e may be an automated timed one (e.g., as a milestone) in some embodiments, as settlement is established by the market.

In an embodiment, a closed status 260f may indicate that the liquidity management system 130 may no longer make any further payments or trades. In an embodiment, for direct cash clearing, the timing would correspond to the closure of the clearing system, whereas with a correspondent bank the timing would correspond to the deadline that the correspondent banks have established for accepting payments. In some embodiments, the trigger to move from the trading & funding status 260d or settlement status 260e to the closed status 260f may be an automated timed one (e.g., as a milestone), as the timing is established by the market or correspondent bank. During the closed status 260f, the users may take further actions, such as attending to pending user-approvals (e.g., four-eye approvals). It may be appreciated that such approvals may need to be completed before the current day is closed, or prior to the next business day.

As further shown under the forecasting statuses 260, a rolled over status 260g may be provided, which may indicate that the business day is fully completed. In an embodiment, the liquidity management system 130 may be configured to not take any actions during the rolled over status 260g, and positions may be locked down. In an embodiment, the trigger to move the status from the closed status 260f to the rolled over status 260g may be user initiated, and may be manually executed when users have completed all actions for the current day. In an embodiment, an automated snapshot may be taken at the rolled over status 260g, so that the evidence of the position may be kept so that users can go back to it for further reference. In an embodiment, upon roll over at 260g, the forecasting for the next business day may activated with a new not started status 260a, so that all forecasts would be evaluated against the next day's timeline.

As indicated above, in an embodiment milestones may be used to modify the processing of the forecasts over time. In particular, a milestone may provide a currency and account agnostic point in the forecasting day, where various automated actions can be attached. For example, at a milestone, the liquidity management system 130 may change the forecasting status, take automated snapshots, re-bucket forecasts, or so on. In an embodiment, a milestone may be provided after which point new forecasts and updates to existing forecasts may be considered ‘late,’ as further described herein. As shown at 270, milestone processing may be chronologically linked with the forecasting status 260, and the business day 250. In an embodiment, users may set up as many milestones as they desire for driving the various automated actions and forecasting rules. In some embodiments, the milestones may be set up across the whole liquidity management system 130, or across systems of the financial services provider (e.g., the subsystems 110). In an embodiment, milestones may be used to customize the timed behavior of each account (e.g., nostro account). It may be appreciated that a milestone may or may not apply to a particular account (e.g., nostro account). It may be appreciated that milestones may be triggered manually by a user, or automatically at a given time, in various embodiments. In an embodiment the manual or automatic triggering may be customized at the account (e.g., nostro) level so that there is flexibility as to how users wish to operate a particular account. As an example, a start milestone 270a may change the forecasting status 260 to forecasting 260b. In an embodiment, a re-bucketing milestone 270b may be used during one or more re-bucketing processes, described in greater detail below. In an embodiment, a late milestone 270c may be associated with application of a late flag to subsequent forecasts, and may indicate the securities settlement deadline. In an embodiment a processing milestone 270d may change the forecasting status 260 to positioning 260c, and may also be used by forecasting rules for setting the late flag in some embodiments. In an embodiment, a cut position milestone 270e may change the forecasting status 260 to trading & funding 260d, and may take an automated snapshot. In an embodiment, a market settlement milestone 270f may change the forecasting status 260 to settlement 260e. In an embodiment, a market closure milestone 270g may change the forecasting status 260 to closed 260f. In an embodiment, a roll over milestone 270h may change the forecasting status 260 to not started 260a for the next business day. In an embodiment, the roll over processing may occur at the roll over milestone 270h. In an embodiment, a snapshot may be taken at the roll over milestone 270h.

In an embodiment, an account timeline (e.g., a nostro timeline) may be set up, allowing users to customize the behavior of the account. For example, the account timeline may customize the account by selecting which milestones apply, specifying whether they will be triggered automatically at a predetermined time or will be triggered by a user, and specifying a time which will serve as an automated trigger at the predetermined time, or indicative time by which it is expected that a user should have triggered the milestone. In an embodiment, such an indicative time on an account timeline may be used for dashboarding in order to report whether actions are timely taken, or a delay is experienced.

In an embodiment, an automated process may run periodically (e.g., every minute) and may search for any time related set ups which are designated as a time trigger. As such, this milestone server process may routinely scan a plurality of different nostro or other account timelines to determine if one or the other account timelines has a milestone coming up. In an embodiment, if it is determined that a milestone is reached, then the milestone server process may determine if there are any forecasting rule(s) that are set up with re-bucketing for the milestone, and/or if there are any automated actions attached to the milestone. In an embodiment, when a milestone is reached for one or more forecasting rule(s), the liquidity management system 130 may search for forecasts which meet the criteria of the rule(s) and the account for which the milestone was reached. If forecasts are found, then the forecast bucket may be changed as per the setup. In an embodiment, when a milestone is hit for one or more automated actions, the system may execute the predetermined action(s) as per the setup.

In an embodiment, the times on the account timeline may be set up by the user in the local market time (e.g., the time zone where the account is held). In an embodiment, these timings may be translated to UTC (Coordinated Universal Time) so that the milestone server may have standardized timings across all time zones. In an embodiment, the milestone server may be configured to account for changes in daylight savings time for each time zone.

It may be appreciated that the forecasting snapshots described above may describe how forecasts looked at the time a snapshot is taken. In various embodiments, snapshots can be taken automatically at certain milestones or manually by the user. Users can associate the snapshot function with certain milestone as part of the setup in addition to the ones that are already predetermined for them, such as upon cutting the forecasted position for the liquidity decisions (funding between nostros or the trader's investment), and upon roll over to the next business day. In an embodiment, the roll over snapshot may be the final snapshot of the day, and may be used the next day for comparing against the actual balance, so that material differences can be identified, and corrective actions taken, where applicable. In an embodiment, the snapshot data may store the timestamp at the time of the snapshot. Accordingly, in an embodiment when a user wants to go back to a snapshot (on the same business day or going back to previous days) they may select from a list of available snapshots, after which the system may reconstruct the data on the user interface to the same situation as what a user saw at the time that they took the snapshot. In an embodiment, the requested timestamp may be compared against extensive audit trail logging which may enable the user to return back to the forecasts in their state of the time that the snapshot was taken.

As noted above, a transaction typically has two or more legs (e.g., forecasts). In an embodiment, all legs for the same transaction may receive the same forecast decisions, which may reduce the risk that the decisions wouldn't be the same (as may be the case if forecasting rules were applied separately). For example, it is possible that there is a forecasting rule for a specific nostro account, which wouldn't be hit if the forecast for a client account runs through. Accordingly, in an embodiment, the liquidity management system 130 may determine a lead forecast for the transaction, as shown at 280 of process 240. The lead forecast may be understood as a forecast that runs through the rules, before its decision is propagated to all other forecasts for the same transaction (if other forecasts exist). It may be appreciated that this technique may be beneficial to system performance, as it is not pushing every single forecast through the rule, draining system resources.

In an embodiment, the determination of the lead forecast may be based on the availability of a forecast for an account (e.g., a nostro). For example, if the transaction has one forecast for a nostro account, then the forecast for that nostro goes through the forecasting rules. In the unusual case where a transaction has more than one forecast for a nostro account then the forecast for the nostro with the worst deadline (as set up with a particular milestone on the nostro timeline) may go through the rules. In other cases, such as when there are no forecasts for a nostro account available for a transaction, as is the case for a book transfer where one client account gets debited and another client account gets credited, for example, then the first forecast that is picked up by the system may go through the rules, or the forecast may be selected at random.

In an embodiment, the liquidity management system 130 may provide the functionality to exclude certain accounts from being discovered as a nostro when determining the lead forecast. For example, such exclusion may be used in the nostro-vostro relationship between legal entities of the same banking group. For example, with a UK entity of a banking group with head office in the US making use of its head office for making a USD payment, if a client of the UK entity initiates a USD payment, the accounting entries and forecasts will therefore be a debit to the client of the UK entity in the books of the UK entity, a credit to the nostro which represents the account that the UK entity holds with its US entity in the books of the UK entity, a debit to the UK's entity client account with the US entity, which is the so called ‘vostro’, in the books of the US entity, and a credit to the nostro which represents the account that the US entity holds in the US clearing (Fed or Chips) in the books of the US entity. It may be appreciated that the nostro-vostro relationship may be internal, and the true market facing nostro is the one held by the US entity. Therefore the nostro-vostro relationship may be set up to be eliminated from the lead forecast determination, and in such an example only one nostro might be retained (e.g., the nostro held by the US entity in the US clearing).

In an embodiment, an exception where not all forecasts for the same transaction get the same decision may relate to contractual transactions. It may be appreciated that transactions are either ‘actual’ or ‘contractual’. They may be considered actual if both the client and the nostro (i.e. market account) get debited and credited with the actual postings after the transaction is finalized/confirmed. However, for contractual transactions, the client's side may be posted regardless of whether the transaction finalizes in the market or not. Therefore for contractual transactions, the client's side will be decided upon as being final and may be assigned to the final bucket, whereas the nostro/market side may follow the regular forecasting rules, which will move it through the various buckets as the transaction moves through its lifecycle. In an embodiment, if a user makes a decision on one of the forecasts of a transaction, then all forecasts for the same transaction may inherit the same decision. Such inheritance may ensure consistency across all forecasts for the same transaction, and may avoid that the user would have to make repetitively the same decision for each of the forecasts for the same transaction. Again the contractual transaction may be an exception to this.

Having determined a lead forecast at 280, forecasting rules 290 may be applied. In an embodiment, the forecasting rules may make three forecast decisions: assign a forecast bucket, forecast status, and late flag to new forecasts, and re-evaluate these decisions as the transaction processing systems send in later updates for them. These decisions are triggered by the arrival of a new forecast or the update of an existing one upon any change to the forecast attributes. The forecasting rules 290 may also support the milestone server to automatically reevaluate earlier decisions at specific times, and re-bucket them if necessary. Such re-bucketing may comprise moving the forecasts from one forecast bucket to another. In an embodiment, the decision may be triggered by a timed process. For example, the attributes of the forecast might not change, but the forecast with the current attributes may be in an unexpected forecast bucket at a given point in time and is therefore re-bucketed.

In an embodiment, each forecasting rule 290 may have associated therewith four components: forecast attributes 300, re-bucketing milestones 310, a late forecast milestone 320, and a forecast decision 330, as discussed in greater detail below.

In an embodiment, a rule may be set up making use of the significance of the amount (i.e. how large it is, and hence how material the impact would be if an incorrect forecasting decision is made). The tolerance for error may be different from once currency to another or even from one account to another in various embodiments. In an embodiment the liquidity management system 130 may be configured to allow a user to define amount ranges to determine what amounts are considered to be material amounts, significant amounts, and non-material amounts. Whether an amount is material to the users, or not, may depend on factors such as the overall volume and value of a currency or the activity that goes through a particular account, local regulations (e.g. the balance cannot exceed a certain amount, or even worse the correspondent bank initiates a foreign exchange to sell off the excess), interest conditions, or so on. In an embodiment, this technique of materiality may be used for putting a forecast in the undecided bucket, as it may allow a user to focus on the lower volume important material decisions, instead of slowing them down and presenting them with a high volume of non-significant amounts.

In an embodiment, by defining forecasting rules which make use of broad concepts of milestones and material amounts it may be possible to work with a limited number of broader forecasting rules which may cover all markets, currencies and deadlines. The amount ranges and the exact timings of the milestones for each of the currencies and the individual nostros may vary across embodiments, in particular if they have a different behavior than the currency of the nostro. In an embodiment, the broad forecasting rules may avoid setting up an excessive number of forecasting rules in order to differentiate every market's own behavior. It may be appreciated that in some embodiments forecasting rules may be established for specific currencies and nostros, because they are indeed part of the forecast attributes 300. In an embodiment, if a particular currency or nostro has a different behavior then the same rule for all the other currencies or accounts, then an exception rule may be prioritized over a broader rule.

In an embodiment, the forecast attributes 300 may be provided by the source transaction processing system(s), and may range from the transaction reference, to the type of transaction, to the value date, and so on. In an embodiment, a subset of the attributes 300 may be used as a deciding factor as to whether a forecast should go into one forecasting bucket versus another. In various embodiments, forecast attributes may include one or more of the currency of the transactions, the legal entity initiating the transaction, the nostro account involved in the transaction, the country where the nostro is held, the type of transaction and its source transaction processing system, the status of the transaction on the source transaction processing system, the status of the transaction on the accounting system, the reason for not having a finalized status, and the materiality of the amount (i.e. how large or small it is). Other attributes 300 may also be applied to the forecasting rules 290, or certain attributes 300 might not apply to certain transactions. In an embodiment, the attributes 300 may be adapted to the available attributes which a given transaction processing system can provide, and which make sense for that particular system and transaction.

In an embodiment, forecast attributes 300 may be used to identify the rule that should be applied to a given forecast. In an embodiment, rules may be established in an order of priority, where a forecast may run through the rules in this order. In an embodiment, when the attributes of the forecasts match the ones set up for the rule, then that rule is applied, and the forecast might not consider any of the rules with a lower priority. In an embodiment, the order of the rules may be defined so that exceptions have a higher priority, and the rules which become less stringent have a lower priority. As an example, rules for specific types of transactions from a number of source systems, such as payment and securities settlement systems, may have a higher priority than a ‘catch-all’ rule with the lowest priority. In an embodiment, the catch-all rule may put the forecast in an undecided bucket if none of the earlier rules were hit. In an embodiment, various attributes may be combined within the same forecasting rule. The regular available query operands and selection criteria can be applied, including but not limited to and, or, =, < >, <, <=, >, >=, in, not in, like, between, not between, and substring.

As described above, forecast buckets may be categories or groupings of forecasts, based on the confidence level that the forecast will actually occur. In an embodiment, one or more of the forecast buckets may include a confirmed bucket, where it is guaranteed that the transaction will be finalized, a final bucket, where there is a very high level of confidence that the transaction will be finalized, a projected bucket, where there is a high level of confidence that the transaction will be finalized, a tentative bucket, where there is a low level of confidence that the transaction will be finalized, and an undecided bucket for user determination of the forecast bucket. In an embodiment, re-bucketing may be the process of re-evaluating earlier forecast decisions at specific times, and moving forecasts from one forecast bucket to another if need be.

The new bucket can be the undecided bucket for the purpose of automatically highlighting the forecasts to the users, so that the ones which require user attention are presented to them, as opposed to the users needing to search for them. In an embodiment, this allows the users to make an informed decision which may involve contacting an operational area within the financial services provider or the client or counterparty, to verify the status of the transaction. In an embodiment, an example of such a transaction may be a client preadvising a receipt of funds where the confirmation of the receipt of funds is not yet received after the market has been open for most of the day and now the deadline is approaching. In an embodiment, the timing threshold may be controlled by a user set up. It may be appreciated that the forecasting rule for this type of transaction may be set up to put the forecast in the ‘projected’ bucket. With re-bucketing, users can add a re-bucketing milestone (e.g., re-bucketing milestone 270b) to this rule, in order to find such an unconfirmed item at the desired time and move it to the ‘undecided’ bucket. This will take the forecast out of position until the user decides to put it back into position by putting it back into the projected bucket or keep it out of position by putting it into the tentative bucket, for example.

In an embodiment, the new bucket can also be a bucket other than the ‘undecided’ bucket. Here the user doesn't need to take a decision and the automated process can do it on behalf of the user. For example, one such transaction may be a client's DVP securities trade (delivery of securities versus cash payment) where it is expected to receive securities from the counterparty against the client paying cash. In some embodiments, the forecasting rule would be set up to put this transaction in the ‘projected’ bucket as long as the settlement confirmation is not received. In an embodiment, if there is no confirmation of the settlement of the trade before the securities settlement deadline in that particular market for that particular type of security (e.g., a Swedish government bond), then re-bucketing may be considered depending on the reason as to why the trade is failing. For example, if the reason is related to the counterparty not having the securities available to settle the trade, then the user may decide to set the forecasting rule up in such a way to find these particular unconfirmed items at the desired time, and move them automatically to the ‘tentative’ bucket without pushing them to the ‘undecided’ bucket, which may avoid the users taking any action, as they would always make the same decision.

In some embodiments, multiple re-bucketing milestones may be established for the same rule, which may move transactions between buckets as the day in a particular market progresses. For example, this may be the case for a market where the (temporary) local market conditions are such that the strategy for the liquidity decisions is to avoid holding a long balance and have a preference to end up with a short balance instead of a long balance (even though this can cause extra overdraft interest charges).

Returning to the preadvice example discussed above, in an embodiment, the rule could be set up to move the preadvice from ‘projected’ to ‘undecided’ at a given milestone. In addition to that, when it is time to establish the liquidity position the re-bucketing milestone can put them back in ‘projected’ from ‘undecided’, regardless as to whether or not confirmation was received. This would give the users the benefit of knowing what was ‘unconfirmed’ to follow up on the non-receipt of funds. In an embodiment, unless there is certainty that the funds won't be received (at which time they would be put in the ‘tentative’ bucket), the system may be configured to automatically put them back into the ‘projected’ bucket, so that they would be taken into position. In an embodiment, if further updates from the transaction processing system are received after re-bucketing, then they can still get bumped up to a bucket with a higher confidence level as confirmations are received.

In the preadvice example described above, the re-bucketing rule may have put the forecast into ‘undecided’ at a time before the deadline. If the user hasn't made a decision yet, or has already decided to put it in either ‘tentative’ or ‘projected’ bucket, keeping it out or putting it back into position respectively, then if confirmation is received before the late milestone, the forecasting rule may then move the forecast in either the ‘final’ or ‘confirmed’ bucket, depending on from whom the confirmation was received. In case the confirmation was received from the institution where the account is held (e.g., the central bank clearing or correspondent bank) then the rule would put it into the ‘confirmed’ bucket. However if the confirmation was received under the form of an ‘announcement’ sent by the paying bank advising that they will make a payment to the central bank or correspondent account, then the rule may put the forecast into the ‘final’ bucket. In the latter case, it is possible that the confirmation from the institution where the account is held is received after or before the announcement, as messages come in from different parties it is perfectly possible that they come in in any order. If the message is received after, then the re-bucketing may be from the ‘final’ to the ‘confirmed’ bucket. If received before, then there wouldn't be a change in bucket upon the arrival of the announcement, as it wouldn't bump down the level of confidence because the item was already confirmed by a more reliable source (i.e. from the institution where the account is held, as opposed to a third party).

As described herein, use of milestones may facilitate a user identifying late forecasts, which may draw the user's attention to the fact that a new forecast has arrived, or an existing forecast was updated for the current business date, at the time that they are firming up their position for making the liquidity decision, or even after the liquidity position was already taken. Accordingly, a late flag 320 may be assigned by the forecasting rules, depending on whether the data was received before or after the late milestone (e.g., late milestone 270c). In an embodiment, the milestone server might not be used for the determination of the forecast late flag. Indeed, in an embodiment as a new forecast is acquired or an update is received for an existing forecast, then the time at which it is processed may be compared to the nostro timeline and its milestones. In an embodiment, if the forecast comes in for a value date before or equal to the business date, and the time is after a late milestone as per the forecasting rules, then it will get the late flag. In other cases, it might not be considered late.

After applying the forecasting rules at 290 including the attributes 300, re-bucketing 310, and late flag 320, a forecast decision 330 may be made. As shown in FIG. 3, in an embodiment the decision may be based on the forecast status, the forecast bucket, and the forecast late flag. In an embodiment these decisions may initially be taken as a new forecast is received. Then, as updates to an existing forecast are received (if any), the decisions may be revisited as the updated forecast attributes 300 may lead to a different decision, as a different forecasting rule 290 may apply. In an embodiment, a user can then change all or some of these decisions, as they see fit. In an embodiment, another decision, whether the forecast is taken into position or left out of position, may subsequently be made. It may be appreciated that this subsequent decision, described in greater detail below, may be indirectly based on the combination of the above decisions.

As shown at 340, the forecasting rules may assign a forecast status to each forecast. In an embodiment, an active forecast status 340a may be related to an active transaction which hasn't yet posted. As such, the active forecast status 340a may be used for forecasting, and thus may be included in the forecasting buckets for the current business day. In an embodiment, a posted forecast status 340b may be related to a finalized transaction which has already posted. As such, the posted forecast status 340b may therefore no longer used for forecasting, because it is already included in the account balance, and may be excluded from the forecasting buckets for the current business day. In an embodiment a cancelled status 340c may be related to a cancelled transaction which will therefore never take place. As such, the transaction may be removed and no longer used for forecasting, because it will never post. The canceled forecast would then be excluded from the forecasting buckets for the current business day.

As shown at 350, the forecast bucket component of the forecast decision-making may bucket forecasts into categories based on the confidence level that they will actually occur. As indicated above, the forecast bucket assigned to each forecast may subsequently be updated by a user, as desired. As variously described herein, a confirmed forecast 350a may be those forecasts which have been confirmed by the market (i.e. by the correspondent, central bank, or clearing house). For example a confirmed forecast 350a may apply when a payment is sent to the cash clearing or a correspondent bank and they return a confirmation after they have settled the transaction. A final forecast 350b may include those forecasts which aren't yet confirmed by the market, but there is a very high confidence level that they will occur. For example, a final forecast 350b may apply when a payment is sent to the cash clearing or a correspondent bank then, under normal circumstances, there is no reason as to why this payment wouldn't be executed. A projected forecast 350c may include those forecasts for which there is no absolute certainty that they will take place but there is enough confidence to take them into position. For example, a projected forecast 350c may apply where a client has preadvised incoming funds and they have confirmed that the funds will indeed be received. A tentative forecast 350d may include those forecasts for which there is no positive indication that they will take place and there is therefore not enough confidence to take them into position. For example tentative forecast 350d may apply where a security settlement trade with a failed reason code of the counterparty not having enough securities to settle the trade is likely to fail for the current business day. In an embodiment, an undecided forecast 350e may be those forecasts for which a user is required to make a decision. In an embodiment, specific rules can determine that user intervention is required, or if no rule is found, then by default they may be presented to a user.

In some embodiments the level of confidence may increase as a transaction goes through a transaction life cycle. For example if a payment is received before value date then it may be likely to get assigned to the projected bucket 350c. Then on the value date when the payment is sent to the market, after ensuring that the client has enough funds or overdraft line, the confidence level may increase and hence the forecast bucket 350 may be increased to the final bucket 350b. After confirmation is received from the market that the payment was executed, the forecast bucket 350 may be increased to the confirmed bucket 350a.

As further shown in FIG. 3, a forecast late flag 360 may be assigned by the forecasting rules. This functionality may enable the user to freeze their position at a time of their choice (e.g., upon reaching a particular milestone) and let the liquidity management system 130 present any changes that come in after that. Such an arrangement may be beneficial as the user or trader can potentially still alter their liquidity decision if there is a material impact or organize another funding transfer or trade if the deadlines aren't yet reached and there is still time to react. In an embodiment, if it is too late to take a corrective action then forecasts with a late flag may potentially explain the next day why the forecasted position is different from the statement balance received from the institution where the account is held. For example if a client sends in a late preadvice that they expect to receive funds and it is too late to take an action then the closing account balance with the other bank may be long if the funds are indeed received. In an embodiment, the system may be configured so the user can remove the late flag if they were still able to include it in their position. This may also apply to forecasts on the back of funding and investment decisions as by the nature of the transaction they will come in late. It may be appreciated that because they were taken into account for the purpose of squaring out the position, they are known and expected, so the users may remove their late flag. In an embodiment the late flag would apply to the current business day. If the forecast doesn't post, and hence remains outstanding for the next business day, then the late flag may be removed, because from the next day's perspective, the forecast is no longer late (as the next day is only about to start).

Depending on the combination of the values of the forecast decisions, a forecast may be taken into position or left out of position, as determined at 370. In an embodiment, in order for a forecast to qualify to be taken into position, the forecast would have active status, be in either the confirmed or final or projected forecast bucket, and not have a late flag. In an embodiment, any deviation from this would disqualify the forecast from being taken into position. Accordingly, a forecast may be left out of position if the forecast has either a cancelled or posted status, has a tentative or undecided forecast bucket, or has a late flag.

After deciding whether to take the forecast into position or leave it out of position, the decision may be applied to the other forecasts for the same transaction, as shown at 380. Specifically, once the forecast decision has been taken for the lead forecast, there is a process to apply the decision to all the other forecasts for the same transaction, if any. As noted above, an exception may exist for contractual transactions. In an embodiment, the forecasted nostro position may then be determined. The forecasted nostro position may be used for funding the nostros, or may be provided to the traders for their investment. In an embodiment, the forecasted nostro position may be calculated as the sum of the opening balance, plus the total of the confirmed, final, and projected forecasts (which represent a high and fair confidence level). In an embodiment, tentative and undecided forecasts are left out of position.

In many embodiments, forecasts are received from the source transaction processing applications. However, it is also possible to raise a manual forecast for the purpose of making a (temporary) manual adjustment. In an embodiment, manual forecasts should be short lived, as they should be replaced by an actual transaction later on. The manual forecasts would then serve as a placeholder to enable the user to change the forecasted balances if need be. When manual forecasts are entered by the user, they don't go through the forecasting rules. Instead, the user assigns the appropriate forecast bucket, status and late flag. Once raised, the user can update these with the decisions as usual. In an embodiment, the manual forecasts can be entered with the source transaction processing system reference, in case it is known. As an example, if the communication link between the transaction processing system and the liquidity system would be down, a manual forecast may be utilized. If a transaction is received later on from the source transaction processing system with the same reference, then the manual forecast continues its life with the updates from the source system attached to it. In an embodiment, the process may proceed through the forecasting rules as usual from that point on.

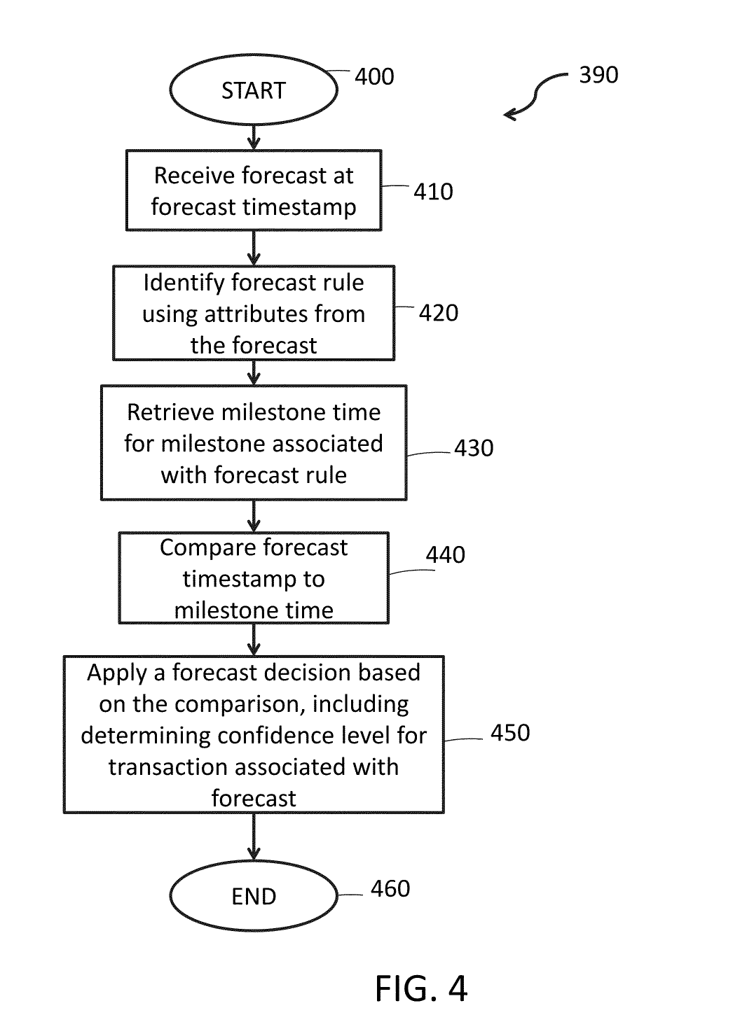

From the disclosure above, it may be appreciated that a method of processing liquidity forecasting decisions may be viewed from the perspective of the liquidity management server 130. Accordingly, as illustrated in FIG. 4, in an embodiment a method for processing liquidity forecasting decisions 390 may start at 400, and proceed at 410 by receiving a forecast for an account at a given forecast timestamp.

Method 390 may then continue at 420 by identifying a forecast rule using attributes from the forecast. For example, in some embodiments, the attributes that can be used to identify the forecast rule may include one or more of a currency of the transaction, a legal entity initiating the transaction, a nostro account involved in the transaction, a nostro holding country, a transaction type, a source transaction processing system, a transaction status associated with a source transaction processing system, a transaction status associated with an accounting system, a reason for not being final, and an amount materiality. Other attributes may additionally or alternatively be used to identify the forecast rule in some embodiments.

It may be appreciated that the forecast rule identified at 420 may include therein milestones, as described in greater detail above. As such, where the forecast rule has a milestone associated with it, method 390 may proceed at 430 by retrieving a milestone time associated with the milestone. In an embodiment, the milestone time may be retrieved from the account associated with the forecast. As indicated above, such milestone times may be in coordinated universal time. It may be appreciated from the disclosure herein that the milestone times may determine how the forecast is treated in the method. Accordingly, method 390 may continue at 440 by comparing the forecast timestamp (which may also be converted into coordinated universal time, or otherwise accounted for) to the milestone time.

As shown at 450, method 390 may continue by applying a forecast decision based on the comparison of the forecast timestamp and the milestone time. It may be appreciated that applying the forecast decision may comprise determining a confidence level that a transaction associated with the forecast will occur by a given time (e.g., where earlier forecasts or forecasts using more reliable data sources may be treated with a greater level of confidence than later forecasts or forecasts using third hand information), as described above. Finally, in an embodiment, method 390 may end at 460.

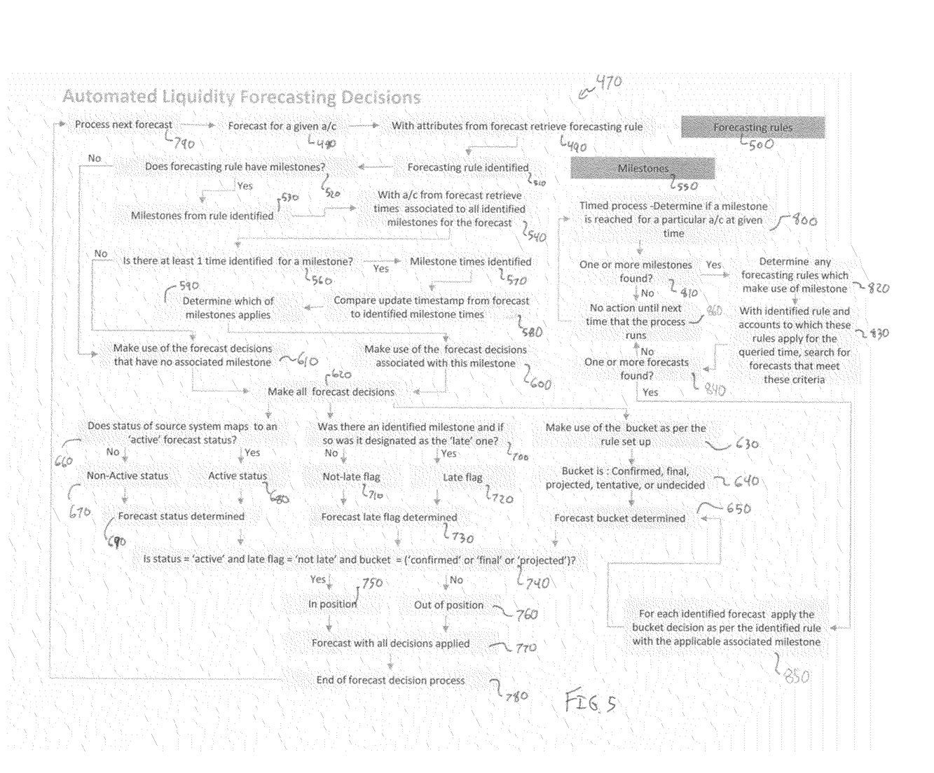

In an embodiment, the method 390, or portions thereof, may be part of a larger decision-making process. For example, as illustrated in FIG. 5, an embodiment of an automated liquidity forecasting decision-making process 470 may include therein various features of the method 390. In an embodiment, the process 470 may comprise a loop that processes a forecast for a particular account (e.g., starting at 480). As shown, at 490, forecasting rules 500 may be retrieved using attributes from the forecast. Once the forecasting rule is identified at 510, process 470 may determine at 520 whether milestones are associated with the forecasting rule. If milestones from the rule are identified at 530, process 470 may proceed at 540 by retrieving times associated with all identified milestones for the forecast, using the account from the forecast. As shown, retrieving the milestone times may be via a milestone process 550, described in greater detail below.

Process 470 may then continue at 560 by determining if there is at least one time identified for a milestone. If milestone time(s) are identified at 570, then process 470 may continue at 580 by comparing an update timestamp from the forecast to the identified milestone times. Following the comparison, if multiple milestone times are identified, process 470 may continue at 590 by determining which milestone applies, before making use of forecast decisions associated with the identified milestone, at 600.

It may be appreciated that no milestones are associated with the forecasting rule (as determined at 520), or if there is not at least one time identified for a milestone (as determined at 560), process 470 may proceed by making use of forecast decisions that have no associated milestones, at 610. Regardless of which forecast decisions are used (at 600 or 610), process 470 may continue by making all forecast decisions, at 620.

In an embodiment, making the forecasting decisions at 620 may include making use of the forecast bucket at 630. Forecast bucketing is described in greater detail above. As indicated at 640, in an embodiment the forecast bucket may be confirmed, final, projected, tentative, or undecided. In an embodiment, the forecast bucket may be determined at 650, as discussed above. In some embodiments, other considerations may ascertain the outcome of decision-making. For example, in an embodiment, the decision-making may include whether the status of the source system maps to an active forecast status, at 660. If not, a non-active status 670 may be indicated, while if so, an active status 680 may be indicated. Accordingly, a forecast status may be determined at 690. In an embodiment, making the forecast decisions at 620 may include determining at 700 if there was an identified milestone, and if so, was it designated as late. If there was not a late milestone, then at 710, a not-late flag may be designated (which in an embodiment, might be understood as the absence of a late flag). If there is a late milestone, then at 720 a late flag may be applied to the forecast. Accordingly, at 730, a forecast late-flag is determined.

In some embodiments, process 470 may continue by determining whether forecasts should be taken into position or left out of position. Accordingly, in an embodiment, as illustrated at 740, if the status is active (e.g. at 680), the forecast late flag is not late (e.g., at 710), and the bucket at 640 is confirmed, final, or projected (as determined at 640), then the forecast may be taken into position at 750. If not, then the forecast may be left out of position, at 760. Accordingly, the forecast may be completed with all decisions applied at 770, and the forecast decision process 470 may end at 780. In an embodiment, the process 470 may loop (as indicated at 790, by returning to the start at 480.

As further shown in FIG. 5, and as discussed above, in an embodiment the milestone process 550 may be a timed process that may run concurrently with the decision-making process (e.g., process 470). In an embodiment, the milestone process 550 may be part of the decision-making process (e.g., process 470). As shown at 800 in FIG. 5, in an embodiment the milestone process 550 may be a timed process, which may determine if a milestone is reached for a particular account at a particular time. As shown at 810, the milestone process at 550 may determine if one or more milestones were found. If so, then process 550 may continue at 820 by determining any forecasting rules which make use of the milestone. With the identified rule and accounts to which the forecasting rules apply for the queried time, milestone process 550 may continue at 830 by searching for forecasts meeting the criteria. If one or more forecasts are found (at 840 of FIG. 5), then for each identified forecast, the bucket decision may be applied as per the identified rule with the applicable associated milestone, as illustrated at 850. It may be appreciated that such bucket decisioning may be fed into determining the forecast bucket 650, as described above. If, in an embodiment, no milestones were found at 810, or no forecasts were found at 840, then milestone process 550 may return to 860, which may hold off on action until the next time the process runs. Accordingly, 860 may loop back to 800 for further processing.

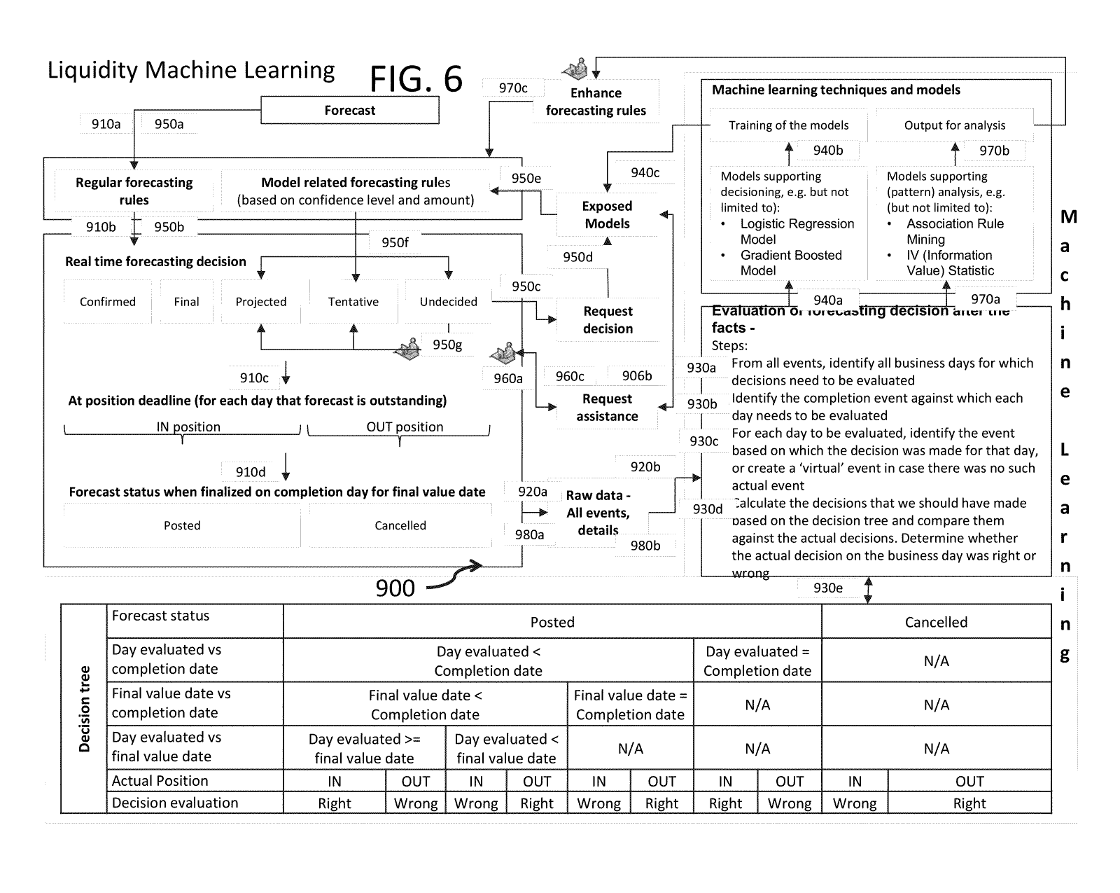

In an embodiment, the method 390, or portions thereof, may include a machine learning and forecasting decision-making process 900. For example, as illustrated in FIG. 6, an embodiment of a machine learning and forecasting decision-making process 900 may include therein various features of the method 390. In an embodiment, the machine learning and forecasting decision-making process 900 may be configured to process prior decisions and outcomes in the past, to support future user and automated decision making. In an embodiment, machine learning and forecasting decision-making process 900 may find patterns within prior decisions and outcomes in the past for the purposes of making more accurate forecasting decisions which lead to better investment of the account balances (e.g. nostro account balances) resulting in increased revenues and reduction in cost. For example, the machine learning and forecasting decision-making process 900 may provide suggested forecasting decisions in real time in situations where regular forecasting rules cannot make an automated decision or where the user requires additional assistance to make an informed decision. In another example, the machine learning and forecasting decision-making process 900 may enhance the regular forecasting rules to further refine the automated forecasting decisions and improve the accuracy of the decisions as to whether a given forecast should be taken into position or not.

In an embodiment, the process 900 may comprise a loop that processes one or more forecasts for one or more particular accounts. As shown, at 910, forecasts may be processed as described above. Specifically, forecasting rules may be retrieved using attributes from the forecast at 910a. Once the forecasting rule is identified at 910a, one or more forecasting decisions are made which may include making use of the forecast bucket at 910b. Forecast bucketing is described in greater detail above. In an embodiment, the forecast bucket may be confirmed, final, projected, tentative, or undecided. In an embodiment, the forecast bucket may be determined at 910b, as discussed above. In an embodiment, at 910c, the decision-making process may determine the forecasted position at the positioning deadline (i.e. milestone) associated with a forecasted position by adding all active forecasts in the completed, final and projected buckets to the opening balance, as described in greater detail above. For example, the positioning deadline may be the time the system provides a position to a trader or the time at which the system moves money around between nostro accounts. A forecast status may be determined as being completed in a step 910d. In some embodiments, process 910d may determine whether forecasts should be posted or cancelled. Accordingly, the forecast may be completed with all decisions at 910d, and the forecast decision process may end. In an embodiment, the process may loop (by returning to the start at 910a) each time an event is received for a forecast with an active status.

In an embodiment, a process 920 may extract transaction data associated with the completed forecasts and transactions. It should be appreciated that a completed event includes forecasts and transactions with a posted or cancelled status. The transaction data may include raw transaction data of all events and forecast details associated with completed forecasts and transactions. In one embodiment the transaction data may include forecasts in any forecasting bucket i.e. confirmed, final, projected, tentative and undecided buckets. At 920a, the transaction data may be extracted from the automated liquidity forecasting decision-making process and system and provided to a machine learning environment at 920b.

As further shown in FIG. 6, the transactions data may be received at the machine learning environment and evaluated after the fact to determine the accuracy of the forecasting decisions at 930. In other words, the transactions data associated with the complete forecasts and transactions may be evaluated by the machine learning environment to determine the accuracy of each forecast decision for each day that the forecast was outstanding. In one embodiment, the transaction data associated with each completed forecast and transaction may be evaluated according to one or more methodologies. For example, process 930 may identify, from the transaction data of all completed forecasting events, all the business days for which forecasting decisions were made at 930a. At 930b, an identification of the event which completed each forecast is determined. For each forecast, the forecasting decisions made for each of the business days that the forecast was outstanding may be evaluated against that forecast's completion event. It should be appreciated that the days that need to be evaluated may include the day of the original value date (value date of the first event when forecast was acquired) and continue up and include the day the forecast is completed.

Process 930 may continue by identifying the last event before the positioning deadline for each day to be evaluated at 930c. It should be appreciated that the forecasting or position decision for a given business day may be taken based on this event. In one embodiment, if no such event is found for a given business day, a virtual event based on the last event available on the next earlier day may be created. At 930d, a decision tree may be utilized to calculate the forecast decision that should have been made for each day to be evaluated. In other words, the decision tree may be used to evaluate whether the forecasting decision for each business day is the correct or most accurate decision made. As shown in the exemplary decision tree table at 930e, the decision tree may input the forecasting status upon completion (posted v. cancelled), completion date (last business day that the forecast was taken into consideration for positioning), final value date (value date of last event which completes the forecast), date that is being evaluated, and the forecasting buckets on the last event for the day that is being evaluated. In one embodiment, the completed, final and projected buckets may be considered to have been taken IN position, whereas the tentative and undecided buckets may be considered to have been taken OUT position. In one embodiment, the output of the decision tree is an evaluation as to whether the decision for that day that is being evaluated was correct.

In an embodiment, process 900 may further continue to evaluate the transactions data with various machine learning models to render a decision as to whether a particular forecast with specific attributes should have been taken into position, or not, and provide a level of confidence for that decision in 940. As shown in 940a, the models may include, but are not limited to, algorithms such as the ‘Logistic Regression’ model and the ‘Gradient Boosted’ model. These models have proven to provide better results than explicate rule-based algorithms. In one embodiment, the machine learning models may learn from one or more training data sets after which quality of the evaluation is determined with a test data set at 940b. In another embodiment, the machine learning models are then exposed to a forecasting processing engine which is utilized for real time decision making at 940c.

As further shown in FIG. 6, process 900 may include real time forecasting decision utilizing the machine learning models described above at 950. In one embodiment, a forecast is initially processed as described above. Specifically, forecasting rules may be retrieved using attributes from automated liquidity forecasting decision-making method processing the forecast at 950a. Once the forecasting rule is identified at 950a, one or more forecasting decisions are made which may include making use of the forecast bucket at 950b. Forecast bucketing is described in greater detail above. In an embodiment the forecast bucket may be confirmed, final, projected, tentative, or undecided. In an embodiment, the forecast bucket may be determined at 910b, as discussed above. If the forecasting rules cannot make a decision and a forecasting decision is placed in the undecided bucket at 950c, a request is sent for a real time forecasting decision utilizing the machine learning models at 950d. In one embodiment, machine learning models may provide the forecasting processing engine a real time forecasting decision for each forecast placed in the undecided bucket. In another embodiment, the machine learning models may provide the forecasting processing engine, in real time, a decision of IN or OUT position; a level of confidence percentage, where 100% represents a very high confidence result and the level of confidence decreases as the percentage lowers; and a list of contributing factors or attributes that added most weight to reach the decision.

Upon receipt of the real time forecasting decision from the machine learning models, model specific forecasting rules defined by the user may be applied at 950e. For example, the user may define specific forecasting rules relating to a confidence level percentage thresholds for material, significant and non-material amounts. In one embodiment, the output of the applied model specific forecasting rules may include direction as to whether the provided decision leads to an automated decision or whether the undecided bucket is assigned to the user to intervene and make a decision. In case the automated decision is taken, the IN position may move the forecast to the projected bucket and the OUT position to the tentative bucket. For example, assume that the material bucket for a USD nostro is defined as requiring greater than 100 million and a confidence level of 95% in order to automate the decision. If a forecast for USD 1 billion comes back with 96% confidence level then the decision is automated, but if the forecast only has a 94% confidence level then it may be presented to the user.

In an embodiment, if the decision is not automated then the user can decide to assign either the projected or tentative bucket independent of what the model suggested at 950g. The user may be presented with the details that the model provided, including the attributes that contributed to the suggested decision so that the user can make the best possible decision based on the available information.

In an embodiment, process 900 may further continue by providing real time assistance to a user at 960. For example, in the event that the user is reviewing a forecast, independent of its forecasting bucket at 960a, a user may request assistance from the model in order to obtain further details which may assist them in their decisions. A request is sent to the model at 960b after which a response is provided back to the user at 960c. The results are rendered on the UI, similarly as to what is available to the user after a forecast goes automatically to the model as part of the automated decision flow.

As further shown in FIG. 6, the forecast processing engine may provide enhanced forecasting rules at 970. In one embodiment, transaction data is evaluated with various machine learning models for the purpose of enhancing the forecasting rules in order to further automate forecasting decisions and improve the accuracy of the decisions at 970a. Examples of the machine learning models include, but are not limited to, the ‘Association Rule Mining’ model and the ‘Information Value Statistic’ model. At 570b, the output of the machine learning models enable the user to analyze the accuracy achieved by each of the rules, discover patterns as to where decisions were right vs. wrong, relations between variables contributing to the outcome, and suggestions as to how the accuracy can be lifted. After their analysis, users have the opportunity to change both the forecasting rules that are used when new or updates to existing forecasts come in, as well as to the rules that are established to handle the suggested decisions made by the model at 570c.

In one embodiment, the transaction data of the completed transactions is extracted from the forecasting processing engine on a regular basis at 580a and provided to the machine learning environment for the purpose of continued training of the machine learning models to further increase the model's accuracy at 580b.

Those skilled in the art will appreciate that the embodiments described herein can be implemented using a server, computer, database, communications and programming technology, each of which implements hardware or software or any combination thereof. Embodiments of this disclosure may be implemented in the form of a computer program product on a computer-readable storage medium having computer-readable program code means embodied in any suitable computer-readable storage medium, including hard disks, CD-ROM, RAM, ROM, optical storage devices, magnetic storage devices, and/or the like.

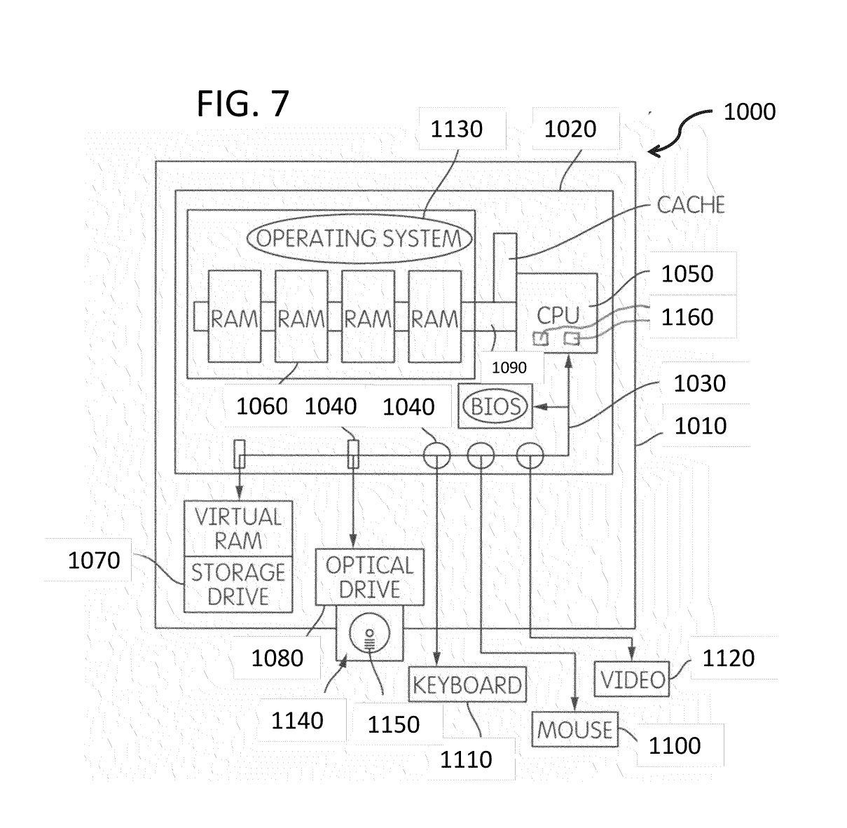

For example, FIG. 7 illustrates a high level block diagram of an exemplary computer system 1000 which may be used to perform embodiments of the algorithms and processes disclosed herein. It may be appreciated that in some embodiments, the system performing the processes herein may include some or all of the computer system 1000. In some embodiments, the computer system 1000 may be linked to or otherwise associated with other computer systems 1000. In an embodiment the computer system 1000 has a case 1010, enclosing a main board 1020. The main board has a system bus 1030, connection ports 1040, a processing unit, such as Central Processing Unit (CPU) 1050, and a data storage device, such as main memory 1060, storage drive 1070, and optical drive 1080. Each of main memory 1060, storage drive 1070, and optical drive 1080 may be of any appropriate construction or configuration. For example, in some embodiments storage drive 1070 may comprise a spinning hard disk drive, or may comprise a solid-state drive. Additionally, optical drive 1080 may comprise a CD drive, a DVD drive, a Blu-ray drive, or any other appropriate optical medium.

Memory bus 1090 couples main memory 1060 to CPU 1050. The system bus 1030 couples storage drive 1070, optical drive 1080, and connection ports 1040 to CPU 1050. Multiple input devices may be provided, such as for example a mouse 1100 and keyboard 1110. Multiple output devices may also be provided, such as for example a video monitor 1120 and a printer (not shown). In an embodiment, such output devices may be configured to display information regarding the processes disclosed herein, including but not limited to the forecast decisions, whether forecasts are taken into position or left out of position, and so on. It may be appreciated that the input devices and output devices may alternatively be local to the case 1010 and the computer system 1000, or may be located remotely (e.g., interfacing with the computer system 1000 through a network or other remote connection).

Computer system 1000 may be a commercially available system, or may be proprietary design. In some embodiments, the computer system 1000 may be a desktop workstation unit, and may be provided by any appropriate computer system provider. In some embodiments, computer system 1000 comprise a networked computer system, wherein memory storage components such as storage drive 1070, additional CPUs 1050 and output devices such as printers are provided by physically separate computer systems commonly tied together in the network. Those skilled in the art will understand and appreciate the physical composition of components and component interconnections comprising computer system 1000, and select a computer system 1000 suitable for performing the methods disclosed herein.

When computer system 1000 is activated, preferably an operating system 1130 will load into main memory 1060 as part of the boot sequence, and ready the computer system 1000 for operation. At the simplest level, and in the most general sense, the tasks of an operating system fall into specific categories—process management, device management (including application and user interface management) and memory management.

In such a computer system 1000, the CPU 1050 is operable to perform one or more embodiments of the methods described above. Those skilled in the art will understand that a computer-readable medium 1140, on which is a computer program 1150 for performing the methods disclosed herein, may be provided to the computer system 1000. The form of the medium 1140 and language of the program 1150 are understood to be appropriate for computer system 1000. Utilizing the memory stores, such as one or more storage drives 1070 and main system memory 1060, the operable CPU 1050 will read the instructions provided by the computer program 1150 and operate to perform the methods disclosed herein, such as processes 470, 390, 240 and/or the functionality described as pertaining to the liquidity management system 130 (including but not limited to providing the forecasting functionality 150).

It may be appreciated that some embodiments the CPU 1050 (either alone or in conjunction with additional CPUs 1050) may be configured to execute one or more computer program modules 1160, each configured to perform one or more functions of the processes described herein. For example, in the illustrated embodiment, at a CPU 1050 operated by the financial service provider, a computer program module 1160 may be configured to receive a forecast. It may be appreciated that the CPU 1050 may be at the liquidity management system 130, and the forecast may be generated using cash balance and transactional data 120 received from the subsystems 110 of the financial services provider. In an embodiment, forecast may comprise data associated with one or more storage drives 1070, accessible by the CPU 1050 directly or indirectly (e.g., via the system bus 1030, or via a network that may be internal to and/or external to the financial services provider). Accordingly, in an embodiment each of the financial subsystems 110 may comprise their own CPUs and storage systems.

It may be appreciated that the one or more computer program modules 1160 may be configured to identify the forecast rule using attributes from the forecast, retrieve milestone times for milestones associated with the rule, compare the forecast timestamp with the milestone time, and apply the forecast decision based on the comparison, as variously described above. It may be appreciated that other features of the various methods and processes described herein may additionally be performed by the one or more computer program modules 1160 operating on the CPU 1050, in coordination with other features of the system 1000.

It may be appreciated that in an embodiment, a computer program module 1160 may be configured to transmit, for viewing on an electronic display communicatively linked with the one or more processors 1050, a graphical user interface, which may be displayed on a display (such as the display 1120). It may be appreciated that the graphical user interface may facilitate transmission of instructions from the user to the liquidity management system 130, which may instruct the computer system 1000 to perform the methods (e.g., methods and processes 240, 390, 470) as described above. It may be appreciated that various actions associated with performing the methods described herein may occur in series or in parallel. Accordingly, it may be appreciated that the program modules 1160 may each be linked with each other, on the same CPU 1050, or across a plurality of CPUs 1050. In effect, in an embodiment, a plurality of modules 1160, operating over one or more CPUs 1050, may cooperate with one another to perform the methods described herein.

The above-discussed embodiments and aspects of this disclosure are not intended to be limiting, but have been shown and described for the purposes of illustrating the functional and structural principles of the inventive concept, and are intended to encompass various modifications that would be within the spirit and scope of the following claims.

Various embodiments may be described herein as including a particular feature, structure, or characteristic, but every aspect or embodiment may not necessarily include the particular feature, structure, or characteristic. Further, when a particular feature, structure, or characteristic is described in connection with an embodiment, it will be understood that such feature, structure, or characteristic may be included in connection with other embodiments, whether or not explicitly described. Thus, various changes and modifications may be made to this disclosure without departing from the scope or spirit of the inventive concept described herein. As such, the specification and drawings should be regarded as examples only, and the scope of the inventive concept to be determined solely by the appended claims.

What is claimed is:

1. A system for processing liquidity forecasting decisions, the system comprising one or more computer processors configured to execute one or more computer program modules, the program modules being configured to:
receive, via the one or more processors, a forecast for an account at a forecast timestamp; and
identify, via the one or more processors, a forecast rule using attributes from the forecast;
responsive to the forecast rule having a milestone associated therewith:
retrieve, via the one or more processors, a milestone time associated with the milestone;
compare, via the one or more processors, the forecast timestamp to the milestone time; and
apply, via the one or more processors, a forecast decision based on the comparison of the forecast timestamp and the milestone time;
wherein applying the forecast decision comprises determining a confidence level that a transaction associated with the forecast will occur by a given time.

2. The system of claim 1, wherein the program modules are configured to determine, via the one or more processors, a lead forecast to be computed for a transaction, the lead forecast being for one of a plurality of legs of the transaction.

3. The system of claim 2, wherein the program modules are configured to determine the lead forecast based on an association with a nostro account.

4. The system of claim 1, wherein the one or more attributes include one or more of a currency of the transaction, a legal entity initiating the transaction, a nostro account involved in the transaction, a nostro holding country, a transaction type, a source transaction processing system, a transaction status associated with a source transaction processing system, a transaction status associated with an accounting system, a reason for not being final, and an amount materiality.

5. The system of claim 1, wherein applying the forecast decision comprises assigning the forecast to one of a plurality of categories associated with a plurality of confidence levels.

6. The system of claim 5, wherein the plurality of categories include one or more of confirmed, final, projected, tentative, and undecided categories.

7. The system of claim 6, wherein forecast decision assigned undecided category is provided real time forecasting decisions utilizing a machine learning model.

8. The system of claim 7, wherein the machine learning model provides a recommended forecast decision, a level of confidence, and a list of contributing factors in reaching the decision.

9. The system of claim 6, wherein the forecast is taken into position if the assigned one of the plurality of categories is confirmed, final, or projected, and wherein the forecast is left out of position if the assigned one of the plurality of categories is tentative or undecided.

10. The system of claim 6, wherein the undecided category is associated with user selection of another of the one or more categories.

11. The system of claim 1, wherein if the forecast is updated after a threshold time, the forecast is indicated as being a late forecast.

12. The system of claim 1, wherein the one or more processors are configured to reevaluate the category of the plurality of categories into which the forecast is assigned based on time or condition triggers.

13. The system of claim 12, wherein the time or condition triggers comprise one or more of the passage of a predetermined time, a securities settlement deadline, an overall processing deadline, and a market settlement deadline.

14. The system of claim 1, wherein the one or more processors are configured to apply the forecast decision by determining if the status of a source system associated with the transaction indicates that the transaction is an active transaction which has not yet posted.

15. The system of claim 1, wherein the forecast is taken into position when the transaction is an active transaction that has not yet posted, the forecast has not updated after a threshold time associated with being late, and the confidence level is above a defined threshold.

16. The system of claim 1, wherein the forecast has been enriched with data from a plurality of sources that contribute to separate forecasts.

17. The system of claim 1, wherein the transaction has a plurality of forecasts associated therewith.

18. The system of claim 1, wherein when one or more milestones are associated with the forecast rule, the one or more processors are configured to:
identify accounts to which the forecast rule applies;
search for other forecasts that meet the criteria of the identified forecast rule; and
for each identified forecast, apply the forecast decision based on the identified forecast rule with the associated milestone.

19. A computer implemented method for processing liquidity forecasting decisions, wherein the method is implemented in a computer system comprising one or more processors configured to execute one or more computer program modules, the method comprising:
receiving, via the one or more processors, a forecast for an account at a forecast timestamp; and
identifying, via the one or more processors, a forecast rule using attributes from the forecast;
responsive to the forecast rule having a milestone associated therewith:
retrieving, via the one or more processors, a milestone time associated with the milestone;
comparing, via the one or more processors, the forecast timestamp to the milestone time; and
applying, via the one or more processors, a forecast decision based on the comparison of the forecast timestamp and the milestone time;
wherein applying the forecast decision comprises determining a confidence level that a transaction associated with the forecast will occur by a given time.

20. The method of claim 19, further comprising determining, via the one or more processors, a lead forecast to be computed for a transaction, the lead forecast being for one of a plurality of legs of the transaction.

21. The method of claim 20, wherein determining the lead forecast is based on an association with a nostro account.

22. The method of claim 19, wherein the one or more attributes include one or more of a currency of the transaction, a legal entity initiating the transaction, a nostro account involved in the transaction, a nostro holding country, a transaction type, a source transaction processing system, a transaction status associated with a source transaction processing system, a transaction status associated with an accounting system, a reason for not being final, and an amount materiality.

23. The method of claim 19, wherein applying the forecast decision comprises assigning the forecast to one of a plurality of categories associated with a plurality of confidence levels.

24. The method of claim 23, wherein the plurality of categories include one or more of confirmed, final, projected, tentative, and undecided categories.

25. The method of claim 24, wherein forecast decisions assigned undecided category is provided real time forecasting decisions utilizing a machine learning model.

26. The method of claim 25, wherein the machine learning model provides a recommended forecast decision, a level of confidence, and a list of contributing factors in reaching the decision.

27. The method of claim 24, further comprising taking the forecast into position if the assigned one of the plurality of categories is confirmed, final, or projected, and leaving the forecast out of position if the assigned one of the plurality of categories is tentative or undecided.

28. The method of claim 24, wherein the undecided category is associated with user selection of another of the one or more categories.

29. The method of claim 19, wherein if the forecast is updated after a threshold time, the forecast is indicated as being a late forecast.

30. The method of claim 19, further comprising reevaluating the category of the plurality of categories into which the forecast is assigned based on time or condition triggers.

31. The method of claim 30, wherein the time or condition triggers comprise one or more of the passage of a predetermined time, a securities settlement deadline, an overall processing deadline, and a market settlement deadline.

32. The method of claim 19, wherein applying the forecast decision comprises determining if the status of a source system associated with the transaction indicates that the transaction is an active transaction which has not yet posted.

33. The method of claim 19, wherein the forecast is taken into position when the transaction is an active transaction that has not yet posted, the forecast has not updated after a threshold time associated with being late, and the confidence level is above a defined threshold.

34. The method of claim 19, wherein the forecast has been enriched with data from a plurality of sources that contribute to separate forecasts.

35. The method of claim 19, wherein the transaction has a plurality of forecasts associated therewith.

36. The method of claim 19, further comprising, when one or more milestones are associated with the forecast rule:
identifying accounts to which the forecast rule applies;
searching for other forecasts that meet the criteria of the identified forecast rule; and
for each identified forecast, applying the forecast decision based on the identified forecast rule with the associated milestone.
